(19) United States
(12) Patent Application Publication
(10) Pub. No.: US 2012/0252379 A1
(43) Pub. Date: Oct. 4, 2012

(54) RESCUE RADIO FOR DIVERS

(75) Inventors: Michael Lever, Vancouver (CA); John W. Nottingham, Bratenahl, OH (US); Jason G. Tilk, Cleveland Hts., OH (US)

(73) Assignee: NAUTILUS LIFELINE LTD., Richmond, BC (CA)

(21) Appl. No.: 13/510,405

(22) PCT Filed: Nov. 17, 2010
(86) PCT No.: PCT/US10/56939

§ 371 Date: Jun. 22, 2012

Related U.S. Application Data
(60) Provisional application No. 61/261,809, filed on Nov. 17, 2009.
(60) Provisional application No. 61/351,341, filed on Jun. 4, 2010.

(51) Int. Cl. H04B 1/38

(52) U.S. Cl. 455/90.1

(57) ABSTRACT

A rescue radio for scuba divers, comprising: an enclosure having a lid and a body; the lid being movable between an opened position and a closed position; a radio system mounted in a core; the core mounted in the body of the enclosure; the core having a cover for the radio system; a first seal formed or provided between the cover and the body to waterproof the radio system to a first depth when the lid is in the opened position; and, a second seal formed or provided between the lid and the body to waterproof the radio system to a second depth when the lid is in the closed position; the second depth being greater than the first depth.

This application claims priority from U.S. Provisional Patent Application No. 61/261,809, filed Nov. 17, 2009, and incorporated herein by reference, and from U.S. Provisional Patent Application No. 61/351,341, filed Jun. 4, 2010, and incorporated herein by reference.

### FIELD OF THE INVENTION

This invention relates to the field of radios and wireless devices for scuba diving, and more specifically, to a rescue radio for scuba divers.

### BACKGROUND

Current radios and wireless mobile communication devices for use by scuba divers may include microprocessors, memory, speakers, headphones, and may run one or more software applications in addition to providing for voice communications.

A scuba diver may use a radio while on the surface of the water to contact his or her dive boat. The effective use and operation of such radios is essential for maintaining diver safety in emergency situations. For example, in emergency situations where the dive boat is not available to retrieve a diver or has left the dive area, it is essential for maintaining diver safety that effective distress communications are available to the diver in order to contact the dive boat so that the diver may be retrieved. In most instances a wayward dive boat may be recalled via surface communication to the dive area to retrieve the abandoned diver. A diver who is left behind at the dive area will realize his or her problem while on the surface of the water and will need to communicate with boats or others who are at or above the surface of the water to effect his or her rescue.

Divers being left behind by dive boats is a big problem. In fact, an estimated 30 to 45 divers get left behind by dive boats or are otherwise lost at sea and consequently die every year. Existing radios and wireless devices for divers are problematic. Some existing devices include Global Positioning System (“GPS”) based locating equipment. However, these devices are typically quite expensive and are cumbersome for a diver to use in an emergency situation. Other radios are not waterproof to the depth attainable by divers using modern diving equipment and hence to not provide adequate protection for divers.

A need therefore exists for an improved rescue radio for scuba divers. Accordingly, a solution that addresses, at least in part, the above and other shortcomings is desired.

### SUMMARY OF THE INVENTION

According to one aspect of the invention, there is provided a rescue radio for scuba divers, comprising: an enclosure having a lid and a body; the lid being movable between an opened position and a closed position; a radio system mounted in a core; the core mounted in the body of the enclosure; the core having a cover for the radio system; a first seal formed or provided between the cover and the body to waterproof the radio system to a first depth when the lid is in the opened position; and, a second seal formed or provided between the lid and the body to waterproof the radio system to a second depth when the lid is in the closed position; the second depth being greater than the first depth.

### BRIEF DESCRIPTION OF THE DRAWINGS

Features and advantages of the embodiments of the present invention will become apparent from the following detailed description, taken in combination with the appended drawings, in which:

FIG. 1 is a front perspective view illustrating a rescue radio with its lid closed in accordance with an embodiment of the invention;

FIG. 2 is a front perspective view illustrating the rescue radio of FIG. 1 with its lid opened in accordance with an embodiment of the invention;

FIG. 3 is a front view illustrating the rescue radio of FIG. 1 with its lid opened and indicating the chat button in accordance with an embodiment of the invention;

FIG. 4 is a front view illustrating the rescue radio of FIG. 1 with its lid opened and indicating the hailing button in accordance with an embodiment of the invention;

FIG. 5 is a front view illustrating the rescue radio of FIG. 1 with its lid opened and indicating the DSC button in accordance with an embodiment of the invention;

FIG. 6 is a rear perspective view illustrating the rescue radio of FIG. 1 with its lid opened and strobe light activated in accordance with an embodiment of the invention;

FIG. 7 is a cross sectional perspective view illustrating the core of the rescue radio of FIG. 1 in accordance with an embodiment of the invention;

FIG. 8 is an extended perspective view illustrating the core of the rescue radio of FIG. 1 in accordance with an embodiment of the invention;

FIG. 9 is a side view illustrating the printed circuit board (“PCB”) of the core of the rescue radio of FIG. 1 in accordance with an embodiment of the invention;

FIG. 10 is a cross sectional view illustrating the rescue radio of FIG. 1 in accordance with an embodiment of the invention;

FIG. 11 is a block diagram illustrating the rescue radio of FIG. 1 in accordance with an embodiment of the invention;

FIG. 12 is a table listing the functionality of the rescue radio of FIG. 1 in accordance with an embodiment of the invention;

FIG. 13 is a front perspective view illustrating a rescue radio with its lid closed in accordance with an alternate embodiment of the invention;

FIG. 14 is a front perspective view illustrating the rescue radio of FIG. 13 with its lid opened in accordance with an alternate embodiment of the invention;

FIG. 15 is a front view illustrating the rescue radio of FIG. 13 with its lid opened and indicating the chat button in accordance with an alternate embodiment of the invention;

FIG. 16 is a front view illustrating the rescue radio of FIG. 13 with its lid opened and indicating the hailing and on/off buttons in accordance with an alternate embodiment of the invention;

FIG. 17 is a table listing the functionality of the rescue radio of FIG. 13 in accordance with an alternate embodiment of the invention;

FIG. 18 is a front perspective view illustrating a rescue radio with its lid closed in accordance with an alternate embodiment of the invention;

FIG. 19 is a front perspective view illustrating the rescue radio of FIG. 18 with its lid opened in accordance with an alternate embodiment of the invention;

FIG. 20 is a front view illustrating the rescue radio of FIG. 18 with its lid opened and indicating the chat button in accordance with an alternate embodiment of the invention;

FIG. 21 is a front view illustrating the rescue radio of FIG. 18 with its lid opened and indicating the hailing and on/off buttons in accordance with an alternate embodiment of the invention;

FIG. 22 is a table listing the functionality of the rescue radio of FIG. 18 in accordance with an alternate embodiment of the invention;

FIG. 23 is a front perspective view illustrating a rescue radio with its lid closed in accordance with an alternate embodiment of the invention;

FIG. 24 is a front perspective view illustrating the rescue radio of FIG. 23 with its lid opened in accordance with an alternate embodiment of the invention;

FIG. 25 is a right side view illustrating the rescue radio of FIG. 23 with its lid closed in accordance with an alternate embodiment of the invention;

FIG. 26 is a cross sectional perspective view illustrating the core of a rescue radio in accordance with an alternate embodiment of the invention;

FIG. 27 is a front perspective view illustrating the core of the rescue radio of FIG. 26 with the inner core wall removed in accordance with an alternate embodiment of the invention;

FIG. 28 is a cross sectional view illustrating the core of the rescue radio of FIG. 26 in accordance with an alternate embodiment of the invention;

FIG. 29 is a top view illustrating the antenna of the rescue radio of FIG. 26 in flattened out position in accordance with an alternate embodiment of the invention;

FIG. 30 is a front perspective view illustrating a rescue radio with its lid closed in accordance with an alternate embodiment of the invention;

FIG. 31 is a front perspective view illustrating the rescue radio of FIG. 30 with its lid opened in accordance with an alternate embodiment of the invention;

FIG. 32 is a front perspective view illustrating a rescue radio with its lid closed in accordance with an alternate embodiment of the invention;

FIG. 33 is a front perspective view illustrating the rescue radio of FIG. 32 with its lid opened in accordance with an alternate embodiment of the invention;

FIG. 34 is a front view illustrating a rescue radio in use with its lid opened in accordance with an alternate embodiment of the invention;

FIG. 35 is a front view illustrating the rescue radio of FIG. 34 with its lid closed in accordance with an alternate embodiment of the invention;

FIG. 36 is a front perspective view illustrating the rescue radio of FIG. 34 with its lid closed in accordance with an alternate embodiment of the invention;

FIG. 37 is a front perspective view illustrating the rescue radio of FIG. 34 with its lid partially open in accordance with an alternate embodiment of the invention;

FIG. 38 is a front perspective view illustrating the rescue radio of FIG. 34 with its lid fully opened in accordance with an alternate embodiment of the invention;

FIG. 39 is a block diagram illustrating the rescue radio of FIG. 34 in accordance with an alternate embodiment of the invention;

FIG. 40 is a front perspective view illustrating the rescue radio of FIG. 34 in a receive mode in accordance with an alternate embodiment of the invention;

FIG. 41 is a front perspective view illustrating the rescue radio of FIG. 34 in a transmit mode in accordance with an alternate embodiment of the invention;

FIG. 42 is a front perspective view illustrating the rescue radio of FIG. 34 in a low battery condition in accordance with an alternate embodiment of the invention;

FIG. 43 is a front perspective view illustrating the rescue radio of FIG. 34 displaying a battery level in accordance with an alternate embodiment of the invention;

FIG. 44 is a rear perspective view illustrating the rescue radio of FIG. 34 with its core in a slid-out position in accordance with an alternate embodiment of the invention;

FIG. 45 is a front view illustrating the rescue radio of FIG. 34 equipped with a lanyard attachment in accordance with an alternate embodiment of the invention;

FIG. 46 is a front view illustrating the rescue radio of FIG. 34 equipped with an arm band attachment in accordance with an alternate embodiment of the invention;

FIG. 47 is an alternate front view illustrating the rescue radio of FIG. 34 with its lid closed in accordance with an alternate embodiment of the invention;

FIG. 48 is a front view illustrating the rescue radio of FIG. 34 with its lid opened in accordance with an alternate embodiment of the invention;

FIG. 49 is a front view illustrating a rescue radio with its lid closed in accordance with an alternate embodiment of the invention; and,

FIG. 50 is a front view illustrating the rescue radio of FIG. 49 with its lid opened in accordance with an alternate embodiment of the invention.

It will be noted that throughout the appended drawings, like features are identified by like reference numerals.

### DETAILED DESCRIPTION OF THE EMBODIMENTS

In the following description, details are set forth to provide an understanding of the invention. In some instances, certain software, circuits, structures and techniques have not been described or shown in detail in order not to obscure the invention.

According to one embodiment, the invention provides a rescue radio for operation on VHF (very high frequency) and other frequencies (e.g., marine band VHF, Citizens' Band (“CB”) frequencies, etc.). The housing of the rescue radio is waterproof to approximately 330 feet when its lid or cap is closed. When the lid is opened, the exposed speaker and microphone are waterproof to approximately 3 feet. The rescue radio is intended to prevent divers from getting lost at sea or left behind by dive boats. It is a wireless mobile communication device and may also be used for kayaking, sailing, and other watersports. The rescue radio incorporates a hinged cap or lid that protects the speaker and microphone from crushing pressure at depth. Opening the cap or lid may allow the rescue radio's antenna to be extended. The rescue radio may be equipped with a GPS display, an imbedded dive computer, a tone generator to transmit GPS information, a medical emergency call button, etc.

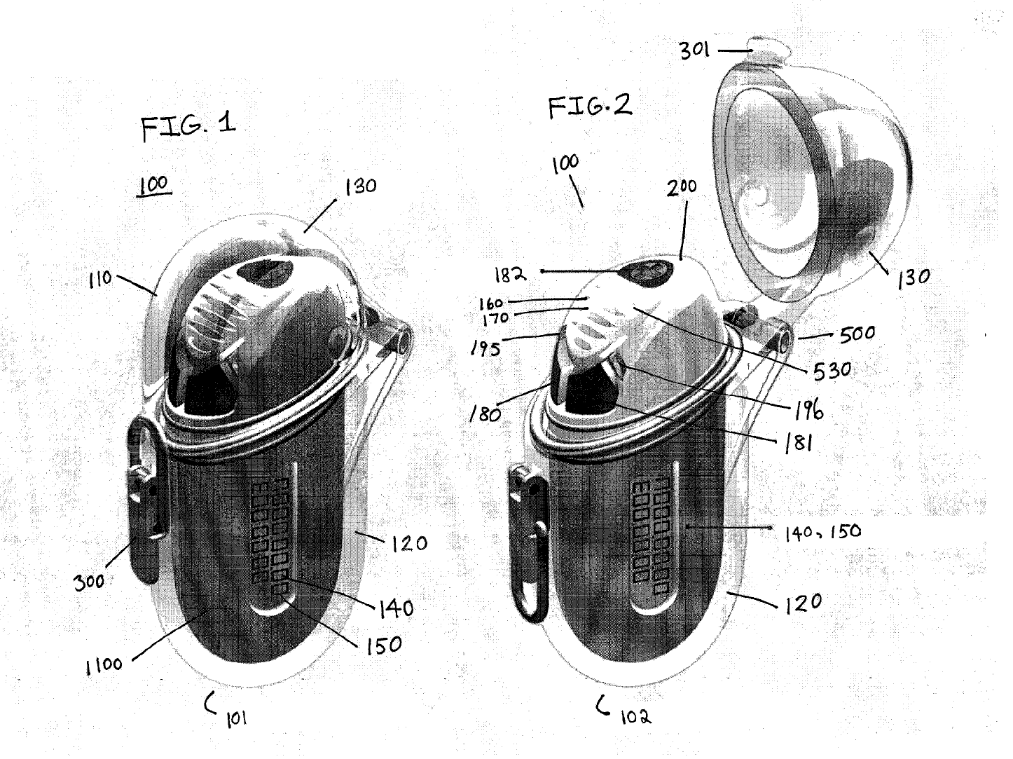

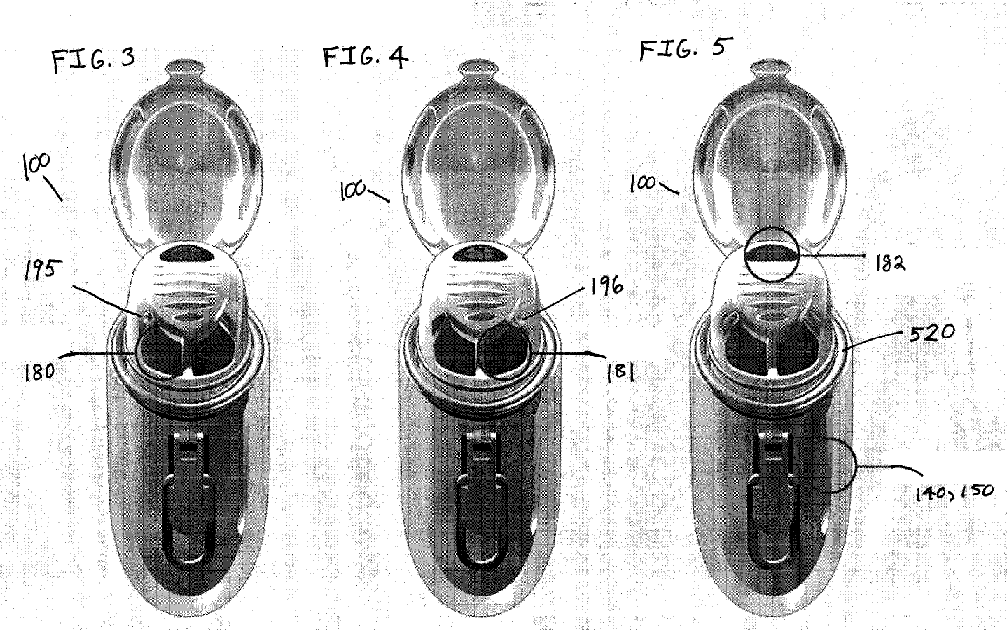

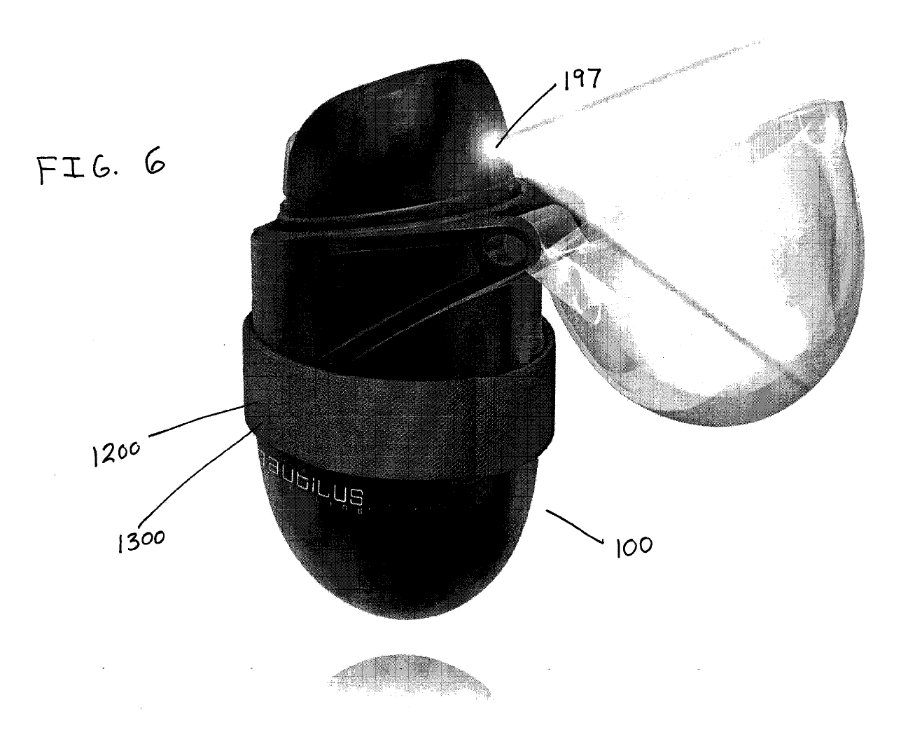

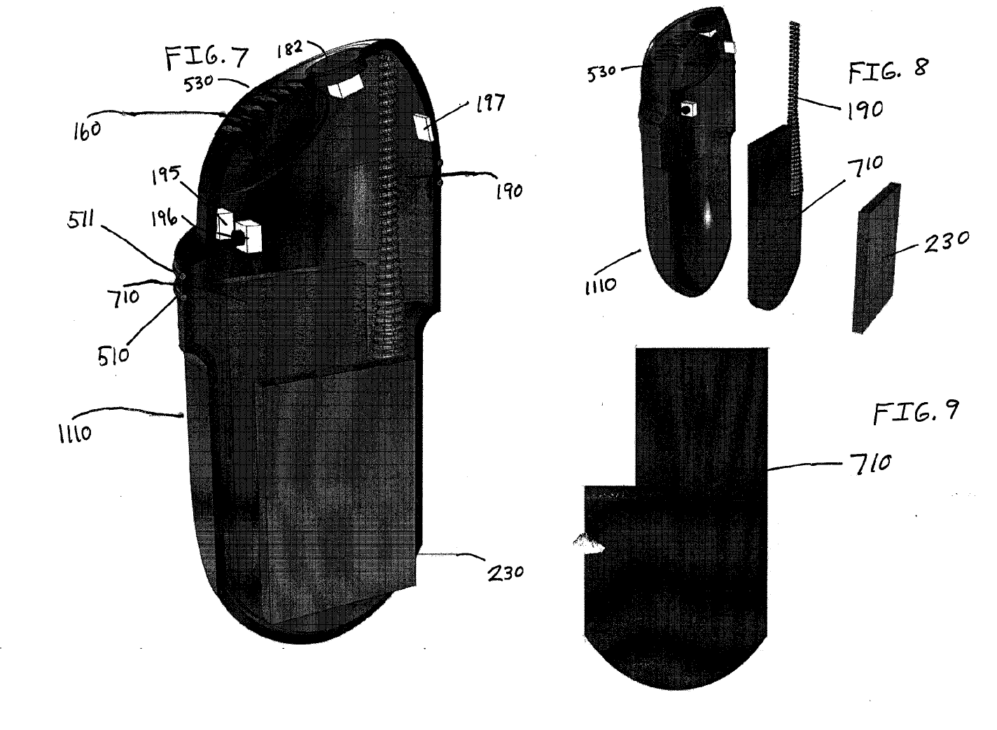

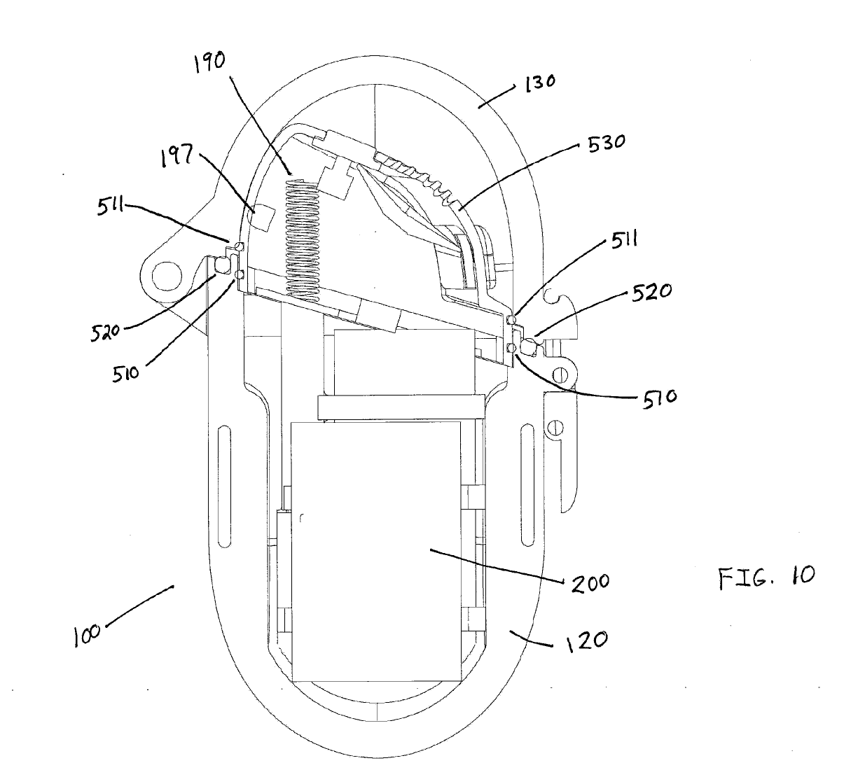

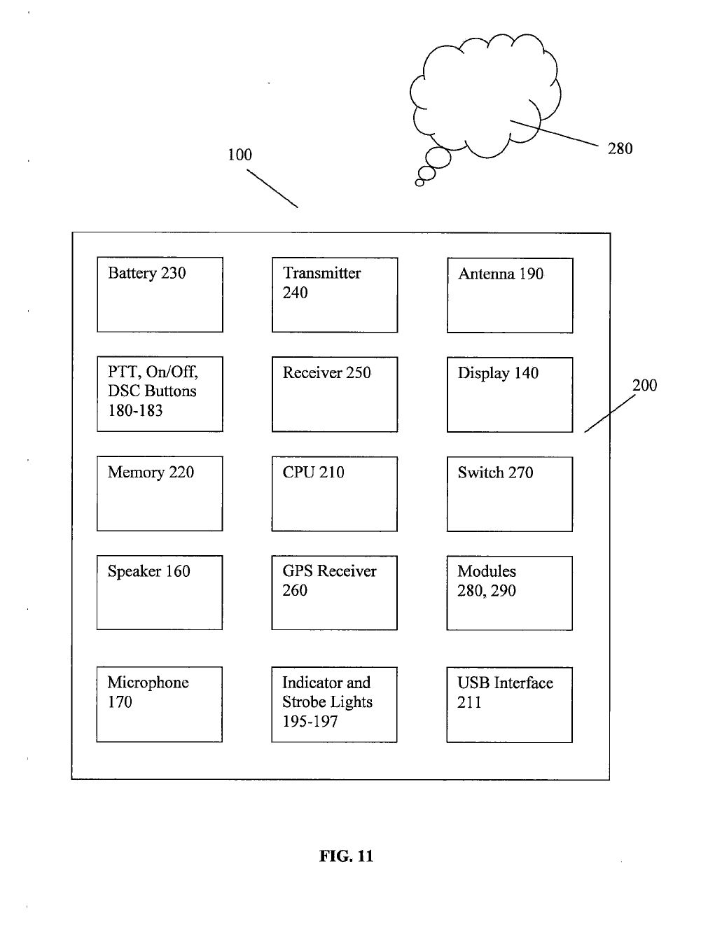

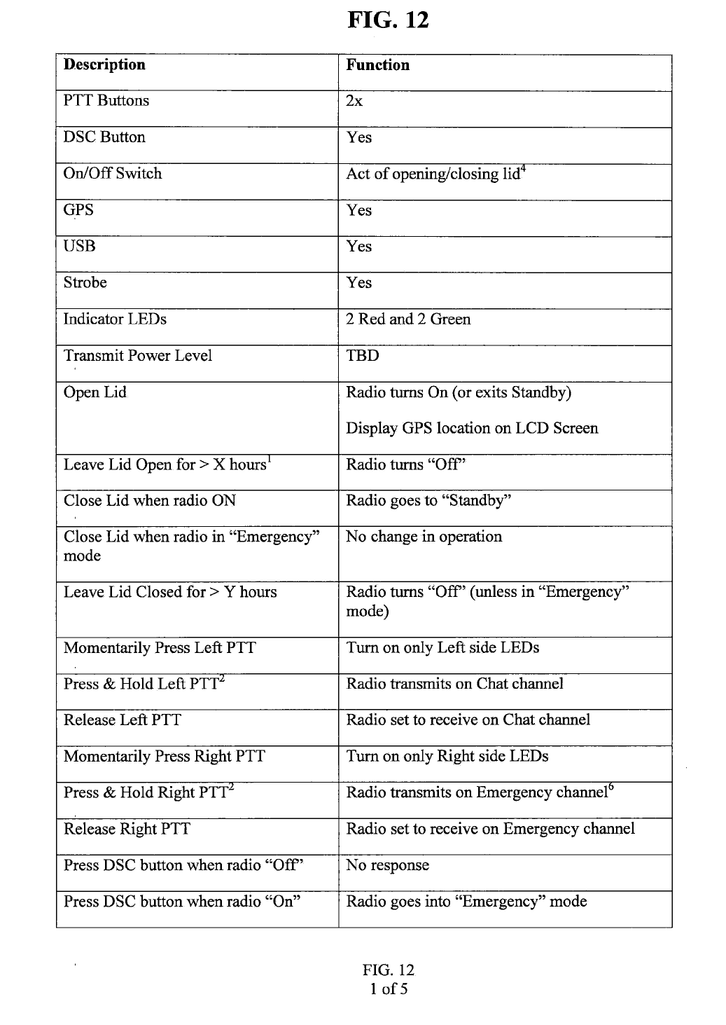

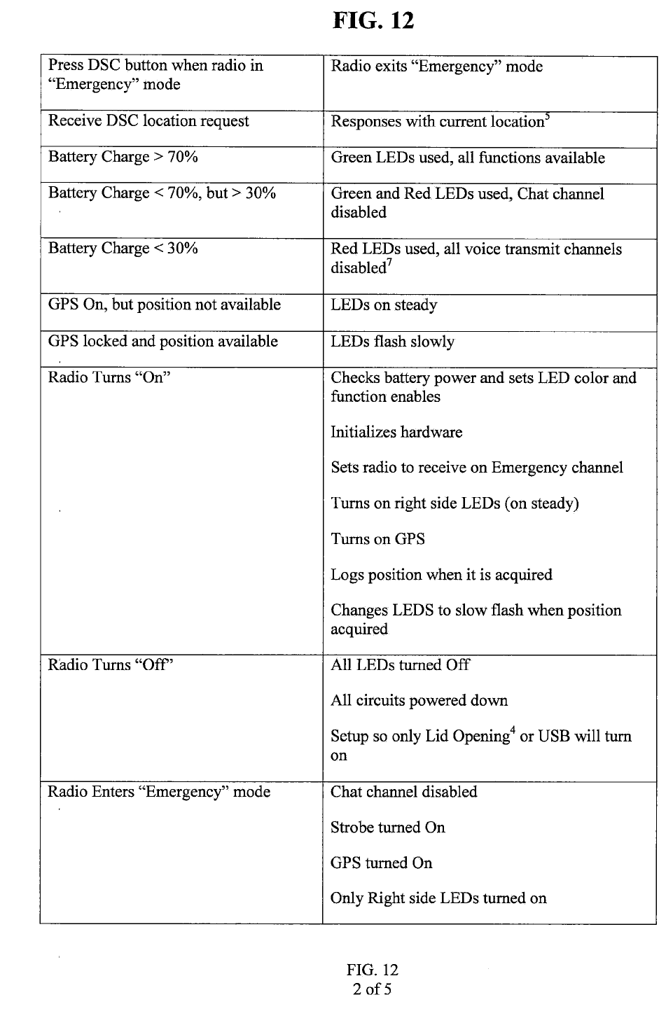

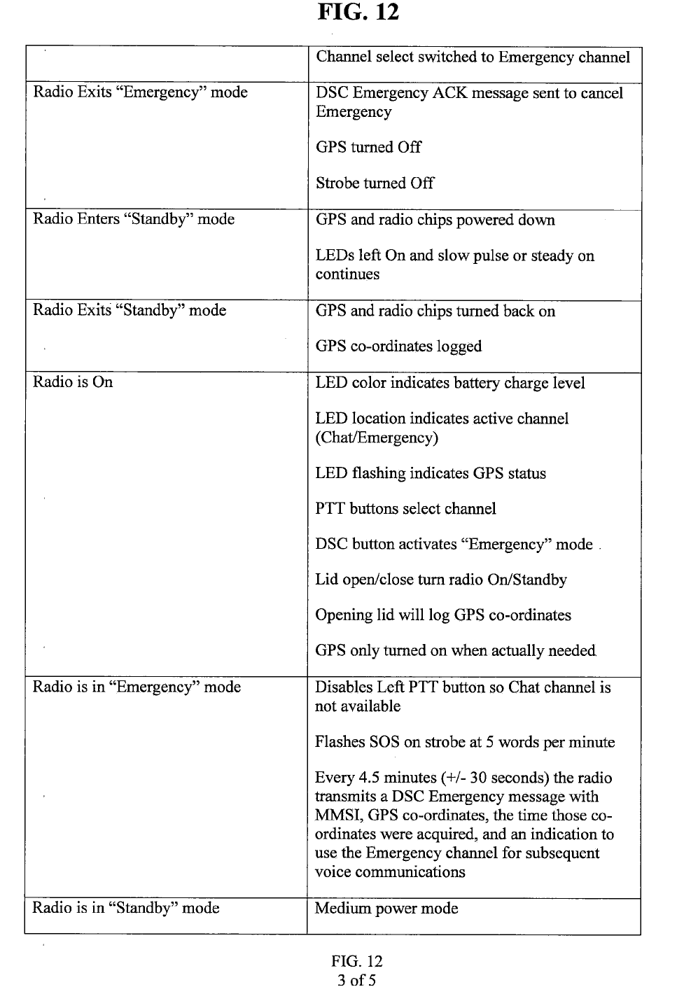

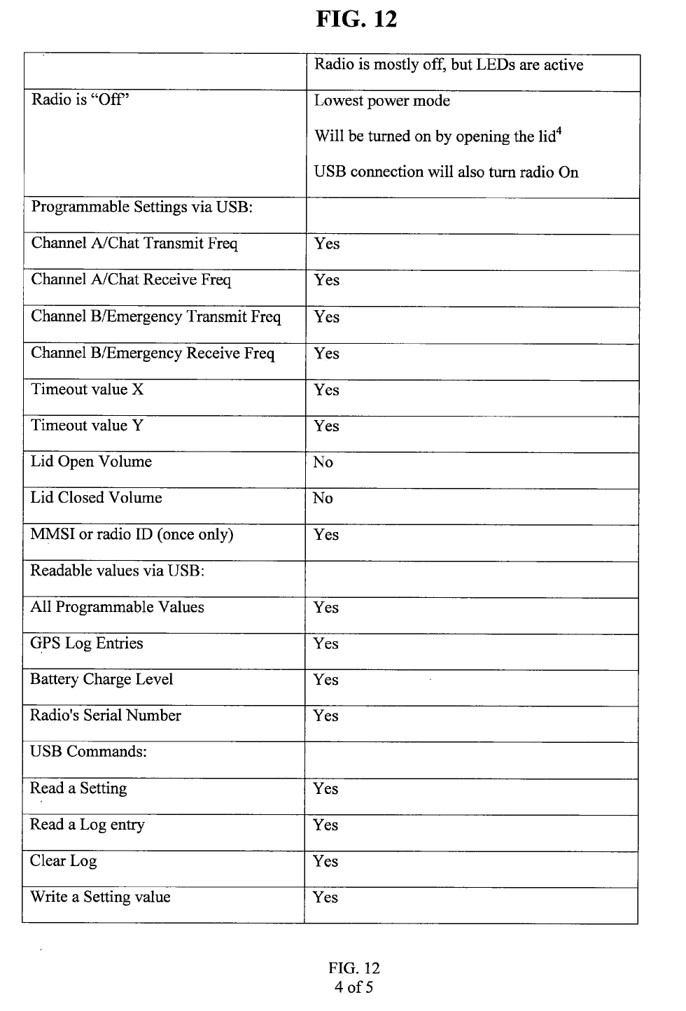

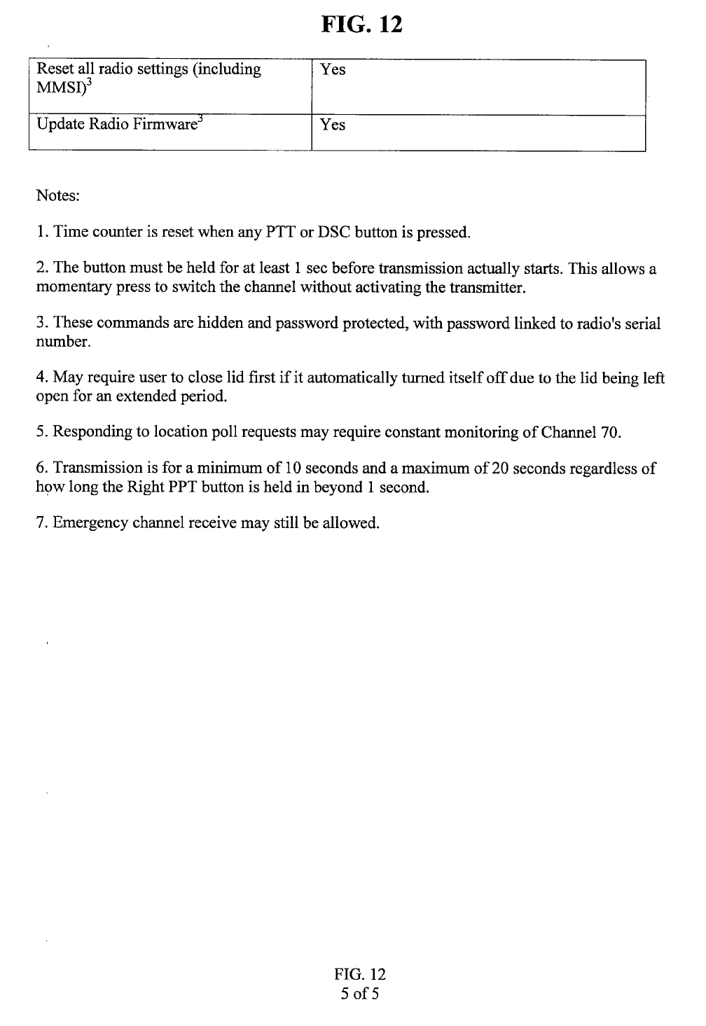

FIG. 1 is a front perspective view illustrating a rescue radio 100 with its lid 130 closed in accordance with an embodiment of the invention. FIG. 2 is a front perspective view illustrating the rescue radio 100 of FIG. 1 with its lid 130 opened in accordance with an embodiment of the invention. FIG. 3 is a front view illustrating the rescue radio 100 of FIG. 1 with its lid 130 opened and indicating the chat button 195 in accordance with an embodiment of the invention. FIG. 4 is a front view illustrating the rescue radio 100 of FIG. 1 with its lid 130 opened and indicating the hailing button 196 in accordance with an embodiment of the invention. FIG. 5 is a front view illustrating the rescue radio 100 of FIG. 1 with its lid 130 opened and indicating the DSC button 182 in accordance with an embodiment of the invention. FIG. 6 is a rear perspective view illustrating the rescue radio 100 of FIG. 1 with its lid 130 opened and strobe light 197 activated in accordance with an embodiment of the invention. FIG. 7 is a cross sectional perspective view illustrating the core 1100 of the rescue radio 100 of FIG. 1 in accordance with an embodiment of the invention. FIG. 8 is an extended perspective view illustrating the core 1100 of the rescue radio 100 of FIG. 1 in accordance with an embodiment of the invention. FIG. is a side view illustrating the printed circuit board (“PCB”) 710 of the core 1100 of the rescue radio 100 of FIG. 1 in accordance with an embodiment of the invention. FIG. 10 is a cross sectional view illustrating the rescue radio 100 of FIG. 1 in accordance with an embodiment of the invention. FIG. 11 is a block diagram illustrating the rescue radio 100 of FIG. 1 in accordance with an embodiment of the invention. And, FIG. 12 is a table listing the functionality of the rescue radio 100 of FIG. 1 in accordance with an embodiment of the invention.

According to one embodiment, the rescue radio 100 includes an enclosure 110 having a body 120 and a cap or lid 130, a display (e.g., a liquid crystal display (“LCD”)) 140, a graphical user interface (“GUI”) 150 displayed on the display 140, and a radio system 200. The radio system 200 includes a speaker 160 (e.g., an electromechanical speaker), a microphone 170 (e.g., an electret microphone), a chat (non-emergency) push-to-talk button 180, a hailing (emergency) push-to-talk button 181, a Digital Selective Calling (“DSC”) button 182, indicator lights 195, 196 (e.g., light emitting diodes (“LEDs”)) associated with each of the push-to-talk buttons 180, 181, and a strobe light 197 (e.g., one or more LEDs) associated with the DSC button 182. Internally, the radio system 200 of the rescue radio 100 may include one or more circuit boards 710, a microprocessor (or central processing unit (“CPU”)) 210 which controls overall operation of the rescue radio 100, memory 220, a battery 230 (e.g., a Lithium ion battery), an antenna 190, a transmitter 240 (e.g., a VHF transmitter), a receiver 250 (e.g., a VHF receiver), an universal serial bus (“USB”) interface 211 for transmitting and receiving information and settings to and from external devices, and a Global Positioning System (“GPS”) receiver 260 (e.g., an L1 Band GPS receiver) which are operatively coupled to the display 140, the speaker 160, the microphone 170, the push-to-talk and DSC buttons 180, 181, 182, the indicator and strobe lights 195, 196, 197, and an on/off switch 270, as will be described below.

The rescue radio 100 may operate over a wireless network 280. The wireless network 280 may include antenna, base stations, access points, transceivers, supporting radio equipment, etc., as known to those of ordinary skill in the art, for supporting wireless communications between the rescue radio 100 and other devices (not shown).

The rescue radio 100 may be a two-way communication device having at least voice and data communication capabilities, including the capability to communicate with other devices. Depending on the functionality provided by the rescue radio 100, it may be referred to as a radio, a wireless device, a data messaging device, a cellular telephone with data messaging capabilities, a data communication device (with or without telephony capabilities), or a portable or handheld radio device. The rescue radio 100 may communicate with any one of a plurality of transceiver stations (not shown) within its geographic coverage area.

The radio system 200 includes computer executable programmed instructions for directing the system 200 to implement the embodiments of the present invention. The programmed instructions may be embodied in one or more hardware modules 280 or software modules 290 resident in the memory 220 of the radio system 200 or elsewhere (e.g., 210).

The microprocessor 210 is coupled to the memory 220. The memory 220 has various hardware and software components for storing information (e.g., instructions, data, database tables, test parameters, etc.) for enabling operation of the rescue radio 100. To provide a user-friendly environment to control the operation of the rescue radio 100, operating system software modules 290 resident on the rescue radio 100 may provide a basic set of operations for supporting various applications which may be operable through the GUI 150 and supporting GUI software modules 290. The rescue radio 100 may be provided with additional hardware 280 and/or software modules 290 for facilitating and implementing various functions.

According to one embodiment, the lid 130 is coupled to the body 120 by a hinge 500. The lid 130 may be secured to the body 120 in the closed position 101 by a latch 300. According to one embodiment, the latch 300 is a locking latch. According to one embodiment, the latch 300 is an over-center latch mounted on the body 120 of the enclosure 110 and which couples to a molded snap detail 301 on the lid 130 of the enclosure 110. Advantageously, the use of this over-center latch and snap 300, 301 does not require an extra action by a diver. In addition, as it requires a deliberate increase in effort and force to open, it reduces the risk of unintentional opening.

According to one embodiment, the enclosure 110 of the rescue radio 100 may have a transparent (or translucent) body 120 and a transparent (or translucent) cap or lid 130.

According to one embodiment, the display 140 is mounted on the outer surface of the core 1100 (or on the inner core wall 1110) such that it may be viewed through the transparent body 120 of the enclosure 110.

According to one embodiment, bore and face seals 510, 511, 520 ensure that the enclosure 110 is waterproof when the lid 130 is closed over the body 120. According to one embodiment, a cover 530 is provided for the radio system 200 which ensures that the radio system 200 is waterproof or water resistant when the lid 130 is in the opened position 102.

According to one embodiment, the microphone 170 is located adjacent to the speaker 160. The microphone 170 and speaker 160 may be protected from the water by a rubber membrane which may be included in or form the cover 530. The microphone 170 and speaker 160 may be waterproof devices.

According to one embodiment, the radio system 200 of the rescue radio 100 may be mounted in a slide-out or removable core 1100 which may be mounted within the body 120 of the enclosure 110. The removable core 1100 may include a battery interface for receiving one or more batteries 230, one or more printed circuit boards (“PCBs”) 710, and the antenna 190. The core 1100 may enclose the radio system 200, PCBs 770, batteries 230, and antenna 190 using a cover 530 and inner core wall 1110.

According to one embodiment, the rescue radio 100 is made waterproof to a depth of 330 feet by the use of an injected moulded housing or enclosure 110 of adequate wall thickness combined with one or more bore O-ring seals 510, 511 and face O-ring seals 520 under the cap or lid 130. According to one embodiment, two bore O-ring seals 510, 511 and one face O-ring seal 520 may be used.

According to one embodiment, the power output of the rescue radio 100 is approximately 4 Watts. According to another embodiment, the power output of the rescue radio 100 is approximately 1 Watt. According to one embodiment, the rescue radio 100 operates in simplex mode. According to another embodiment, the rescue radio 100 operates in duplex mode.

According to one embodiment, in operation, an on/off switch 270 coupled to the lid 130 detects when the lid 130 has been opened and activates the radio system 200. According to one embodiment, the lid 130 acts as the switch 270. According to one embodiment, upon activation of the radio system 200, the geographic position of the rescue radio 100 obtained from the GPS receiver 260 is presented on the display 140 in degrees of longitude and latitude 150.

According to one embodiment, when the chat push-to-talk button 180 is pressed, the user may transmit voice communications on a first channel (e.g., a first VHF channel such as VHF Channel 68). Typically, this first channel would be used for non-emergency voice communications. An indicator light 195 is associated with the operation of the chat push-to-talk button 180.

According to one embodiment, when the hailing push-to-talk button 181 is pressed, the user may transmit voice communications on a second channel (e.g., a second VHF channel such as VHF Channel 16). Typically, this second channel would be used for emergency voice communications. An indicator light 196 is associated with the operation of the hailing push-to-talk button 181.

According to one embodiment, when the DSC button 182 is pressed, the rescue radio 100 transmits a DSC distress signal including geographic position of the rescue radio 100 obtained from the GPS receiver 260 on a third channel (e.g., a third VHF channel such as VHF Channel 70) to dive and rescue boats. Typically, this third channel would be used for emergency non-voice communications. A pulsing strobe light 197 may be associated with the operation of the DSC button 181.

According to one embodiment, the rescue radio 100 includes the functionality listed in FIG. 12.

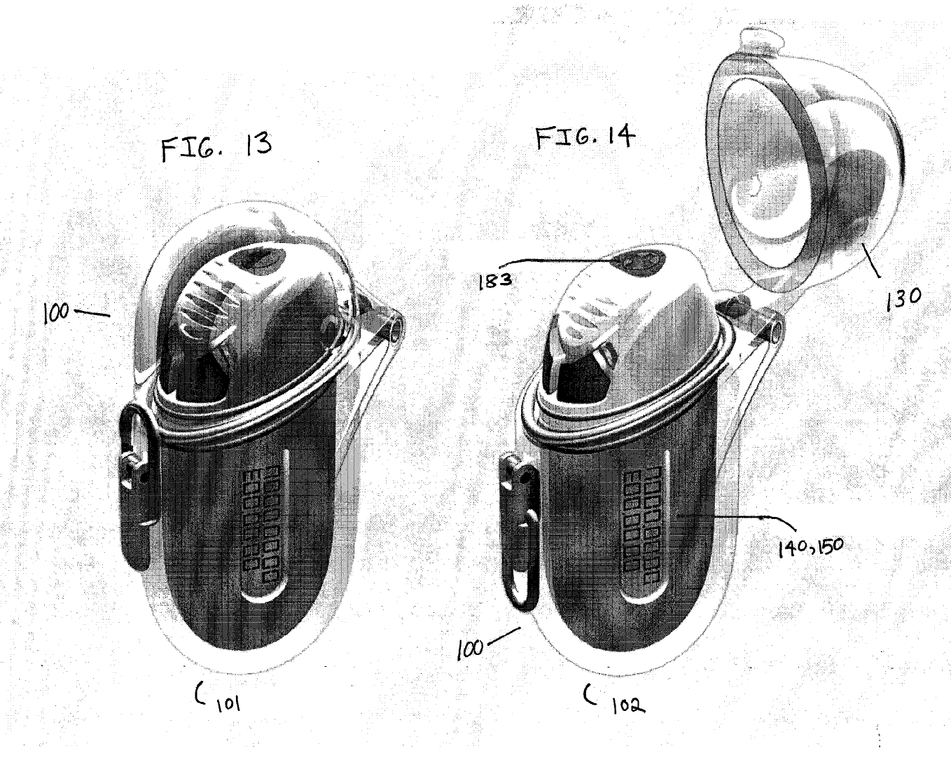

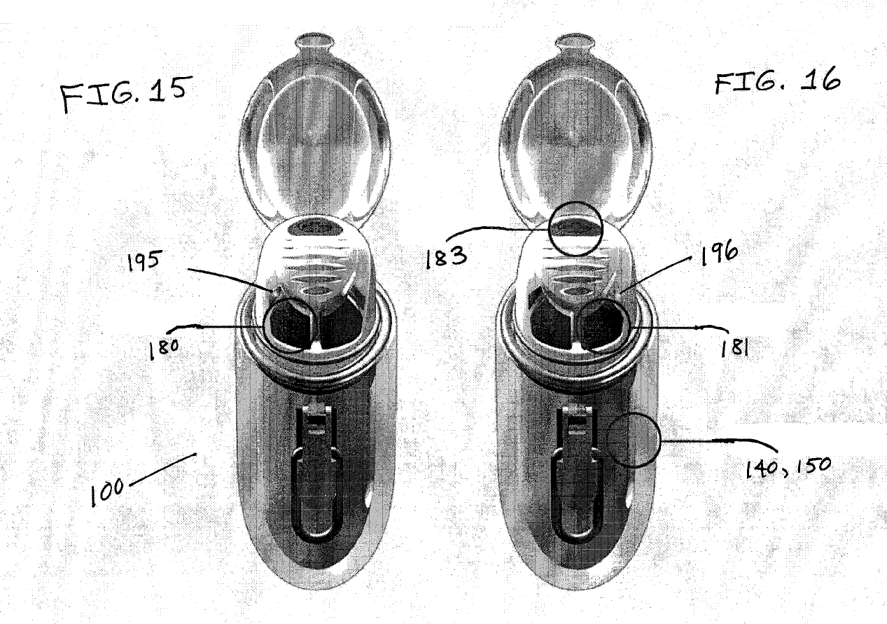

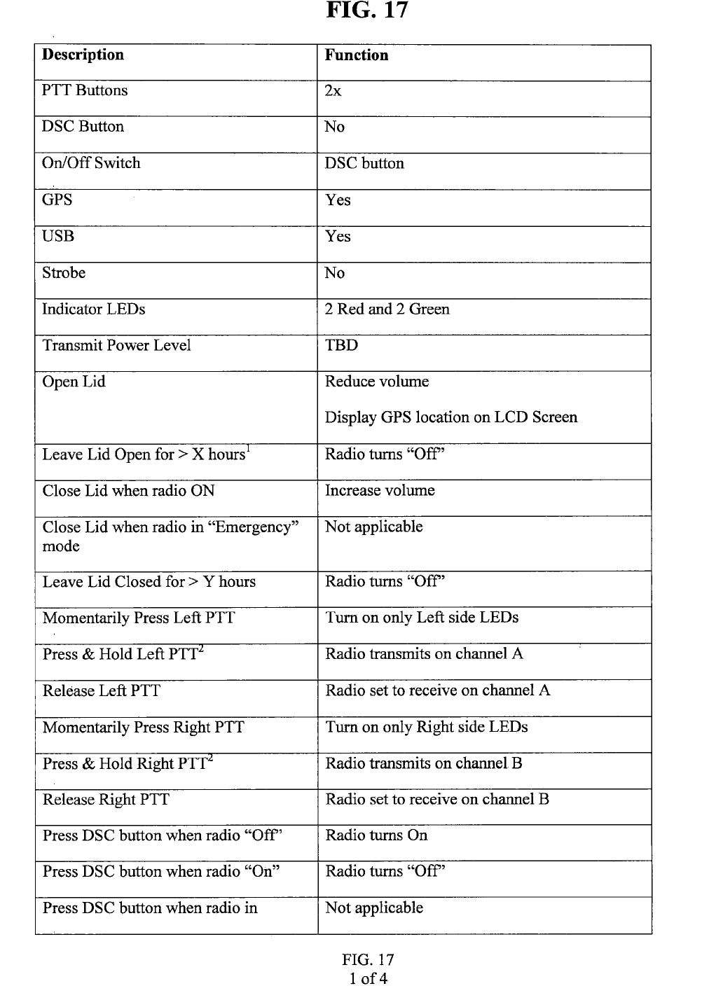

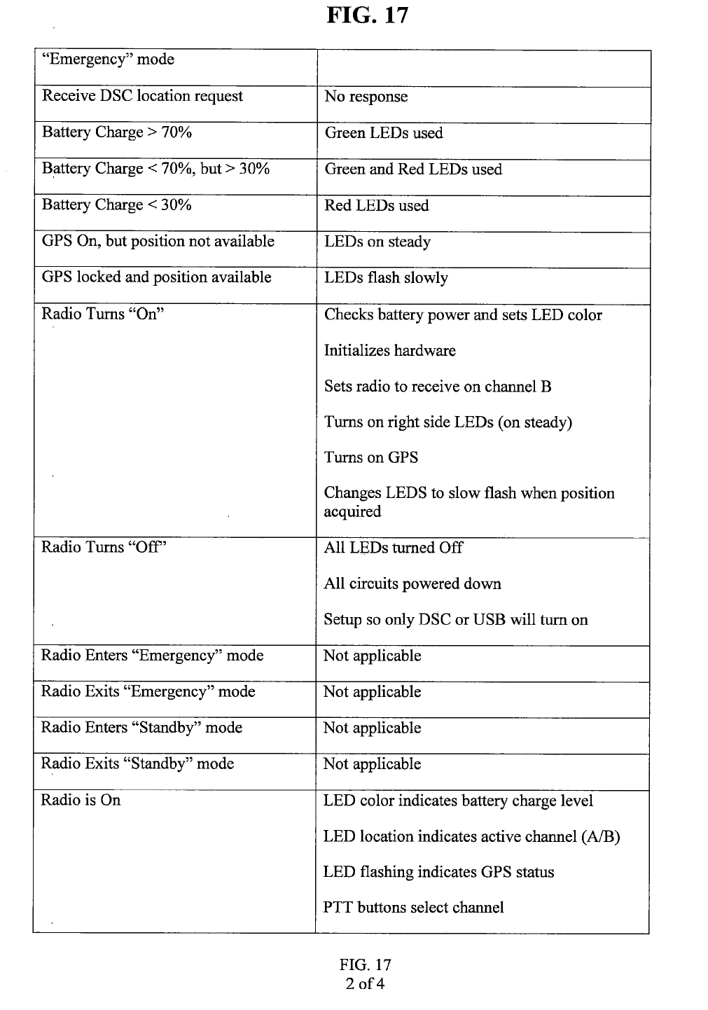

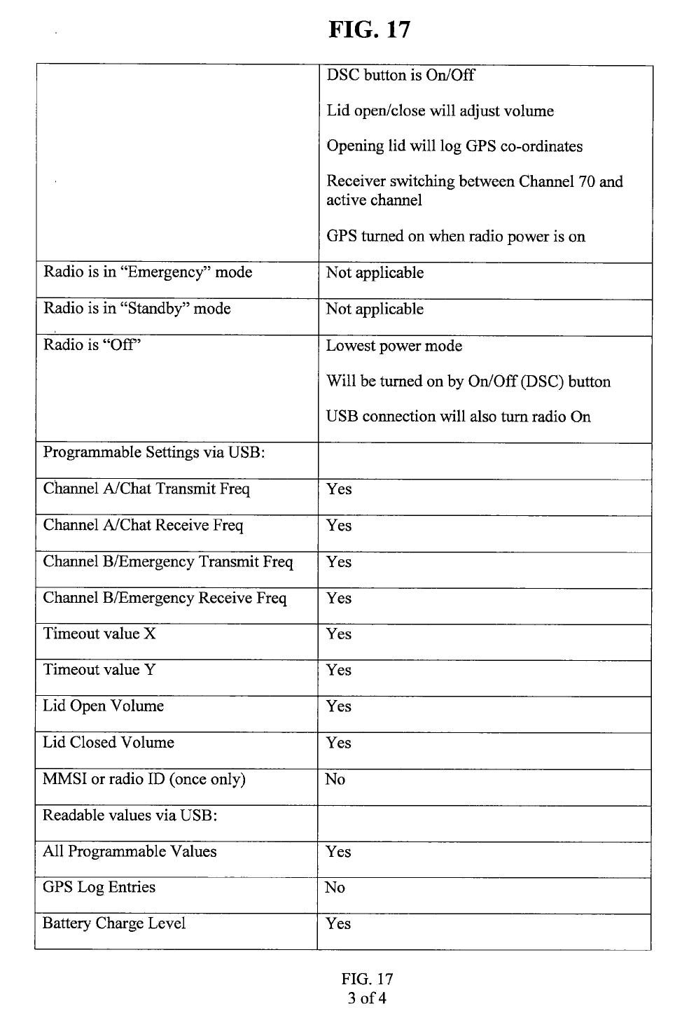

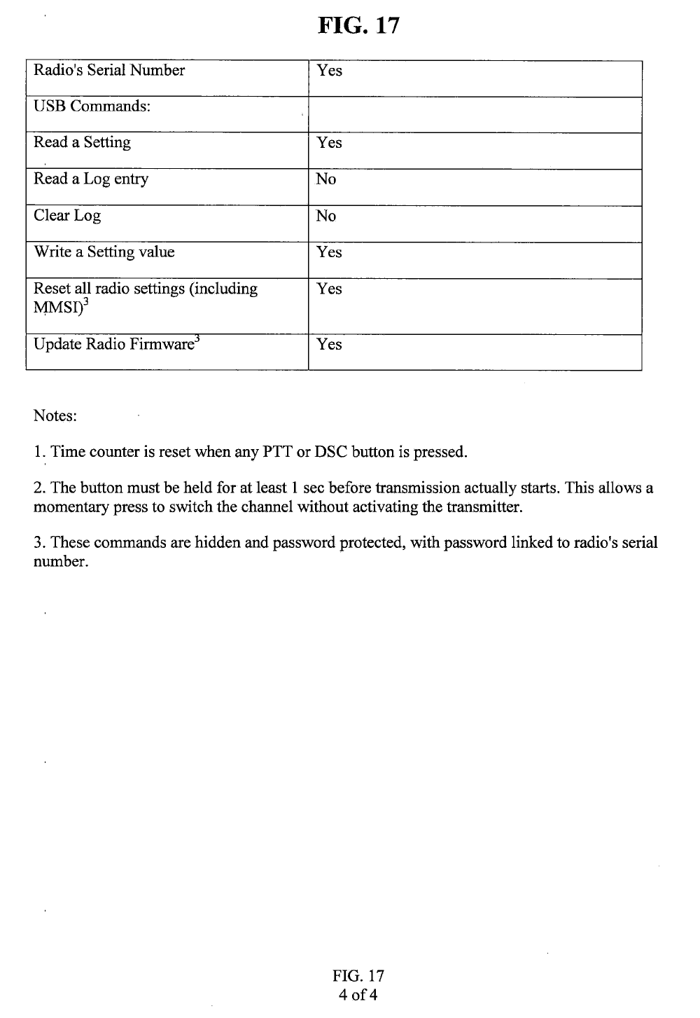

FIG. 13 is a front perspective view illustrating a rescue radio 100 with its lid 130 closed in accordance with an alternate embodiment of the invention. FIG. 14 is a front perspective view illustrating the rescue radio 100 of FIG. 13 with its lid 130 opened in accordance with an alternate embodiment of the invention. FIG. 15 is a front view illustrating the rescue radio 100 of FIG. 13 with its lid opened 130 and indicating the chat button 180 in accordance with an alternate embodiment of the invention. FIG. 16 is a front view illustrating the rescue radio 100 of FIG. 13 with its lid 130 opened and indicating the hailing and on/off buttons 181, 183 in accordance with an alternate embodiment of the invention. And, FIG. 17 is a table listing the functionality of the rescue radio 100 of FIG. 13 in accordance with an alternate embodiment of the invention.

According to an alternate embodiment, the rescue radio 100 does not include a DSC button 182 or strobe light 197. Instead, the rescue radio 100 includes an on/off button 183. The rescue radio 100 may be turned on by pressing the on/off button 183. The cap 130 may be closed after the rescue radio 100 is turned on. Once the cap 130 is closed, the volume of the speaker 160 is increased automatically so that sound emitted by the speaker 160 may still be heard by a diver.

According to one embodiment, the rescue radio 100 includes the functionality outlined in FIG. 17.

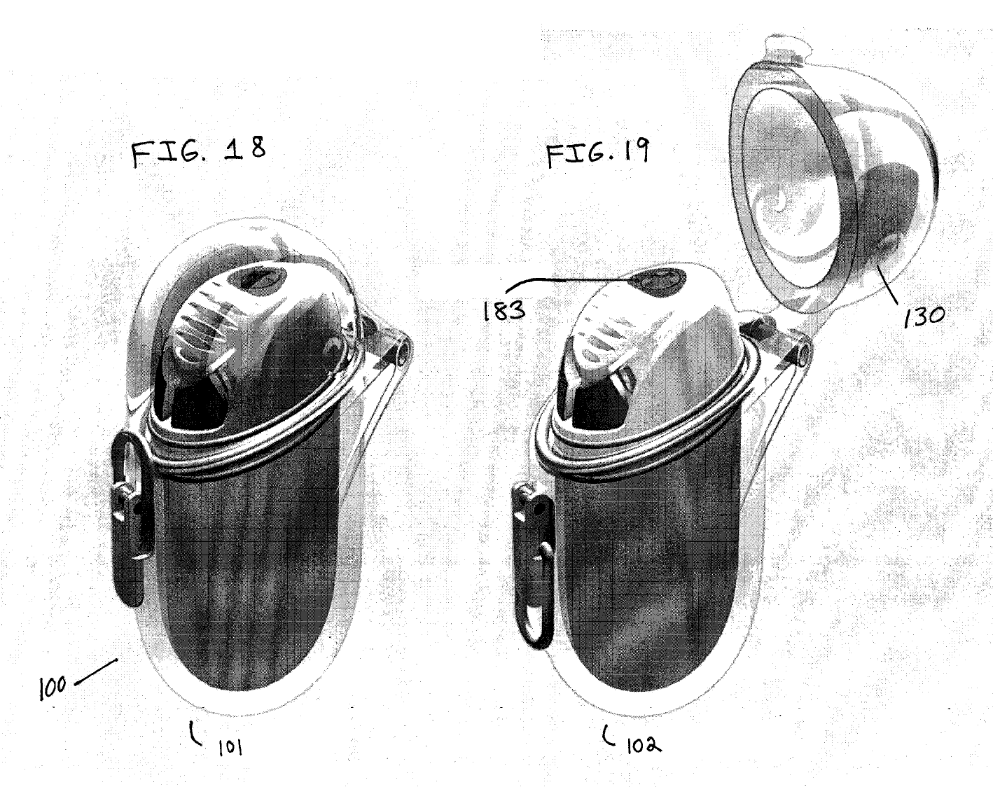

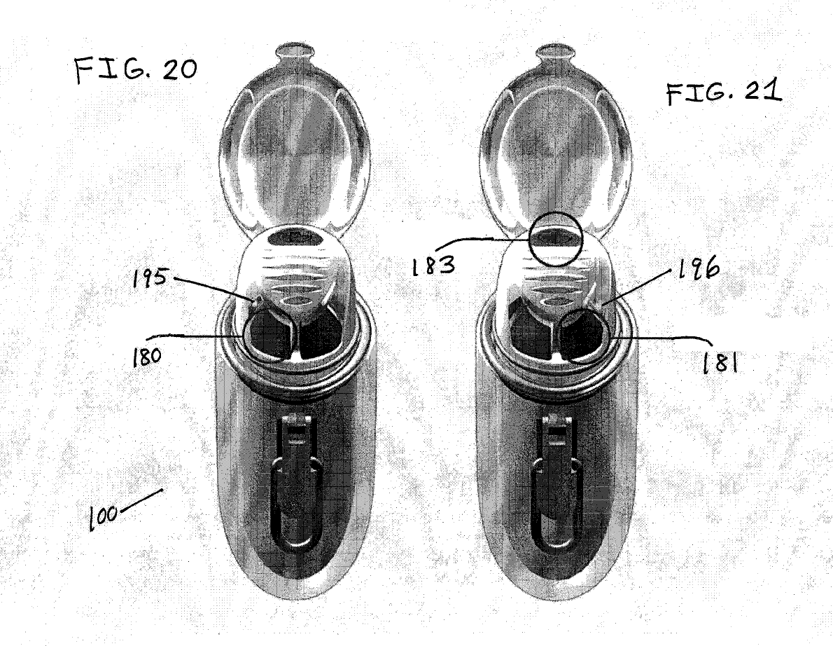

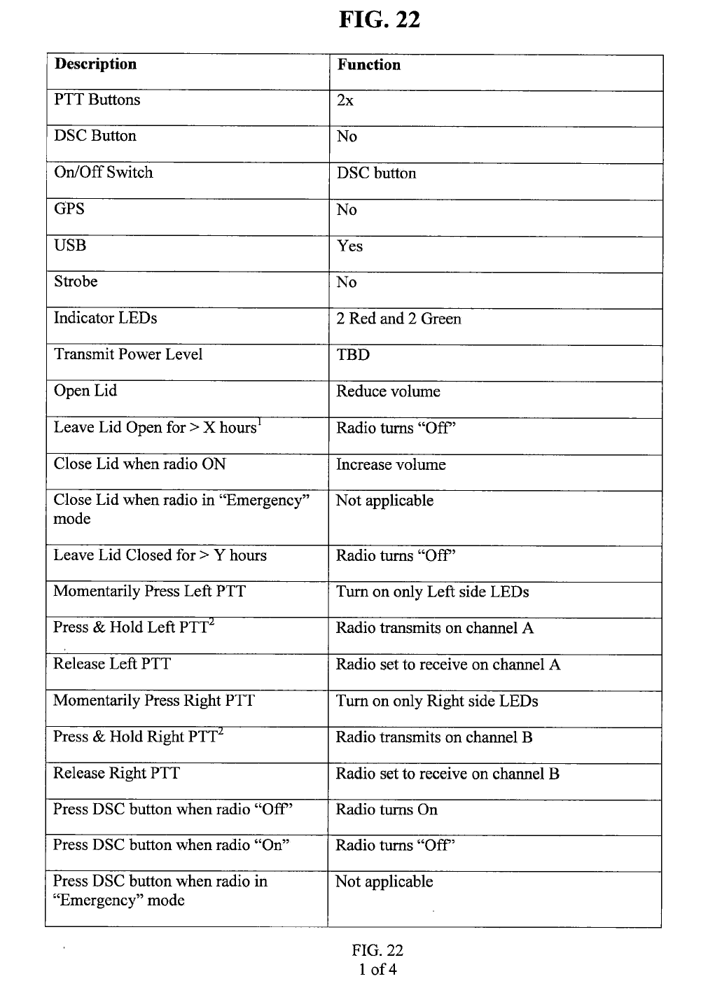

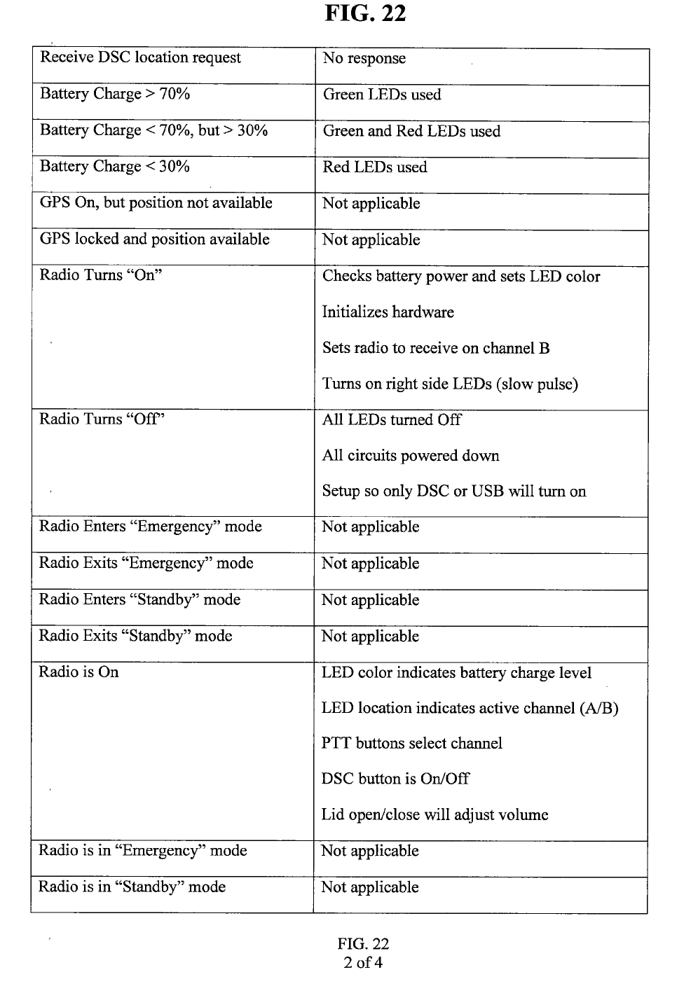

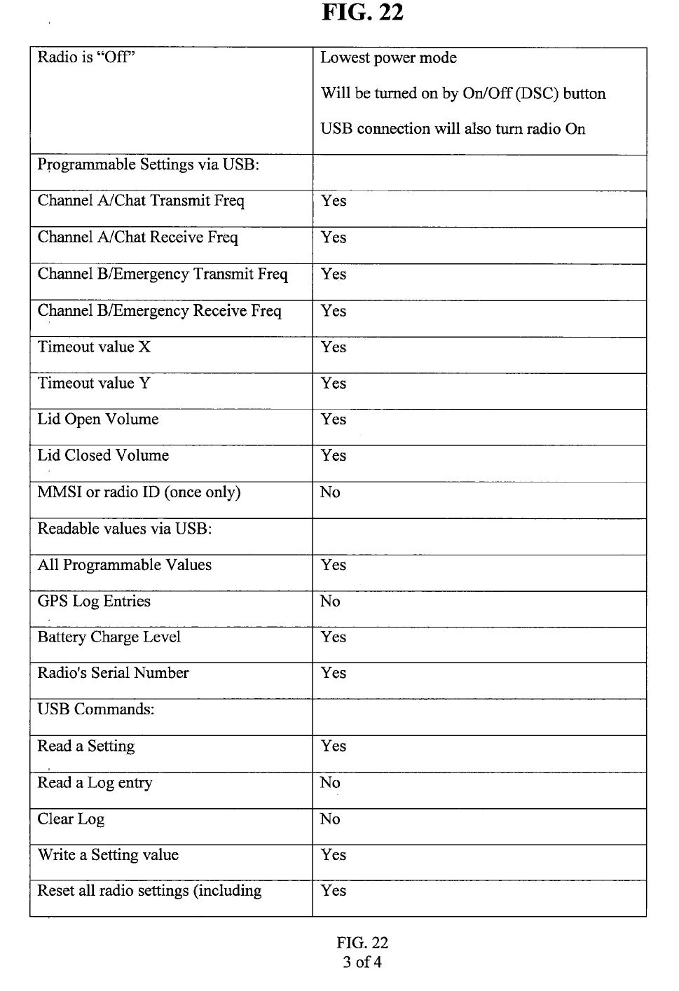

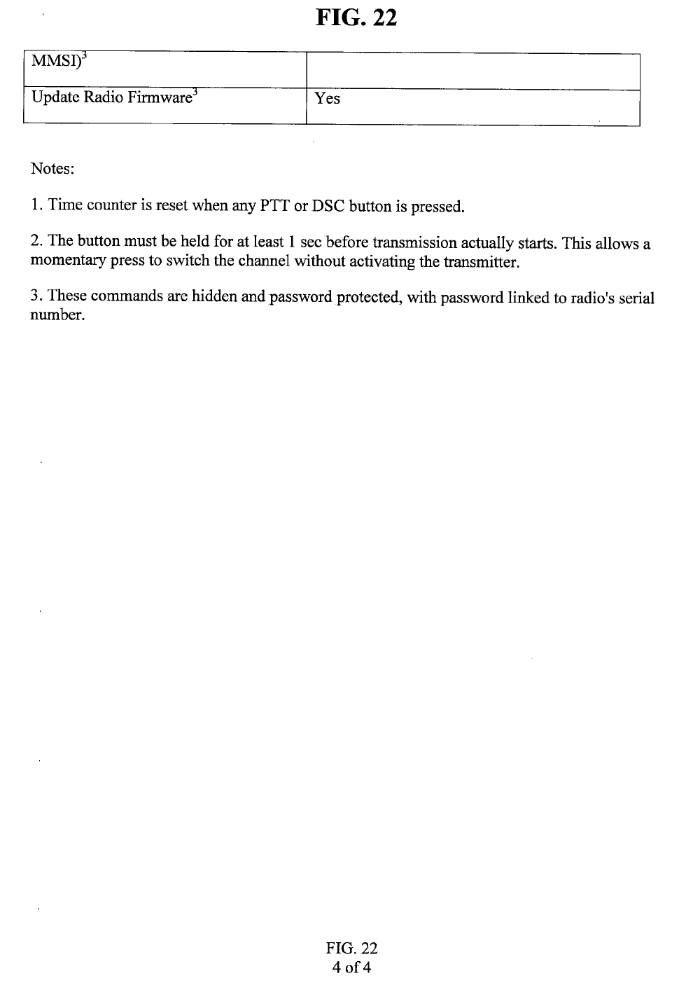

FIG. 18 is a front perspective view illustrating a rescue radio 100 with its lid 130 closed in accordance with an alternate embodiment of the invention. FIG. 19 is a front perspective view illustrating the rescue radio 100 of FIG. 18 with its lid 130 opened in accordance with an alternate embodiment of the invention. FIG. 20 is a front view illustrating the rescue radio 100 of FIG. 18 with its lid 130 opened and indicating the chat button 180 in accordance with an alternate embodiment of the invention. FIG. 21 is a front view illustrating the rescue radio 100 of FIG. 18 with its lid 130 opened and indicating the hailing and on/off buttons 181, 183 in accordance with an alternate embodiment of the invention. And, FIG. 22 is a table listing the functionality of the rescue radio 100 of FIG. 18 in accordance with an alternate embodiment of the invention.

According to an alternate embodiment, the rescue radio 100 does not include a DSC button 182, strobe light 197, display 140, GUI 150, or GPS receiver 260. Instead, and similar to the embodiment of FIGS. 13-17, the rescue radio 100 includes an on/off button 183. The rescue radio 100 may be turned on by pressing the on/off button 183. The cap 130 may be closed after the rescue radio 100 is turned on. Once the cap 130 is closed, the volume of the speaker 160 is increased automatically so that sound emitted by the speaker 160 may still be heard by a diver.

According to one embodiment, the rescue radio 100 includes the functionality outlined in FIG. 22.

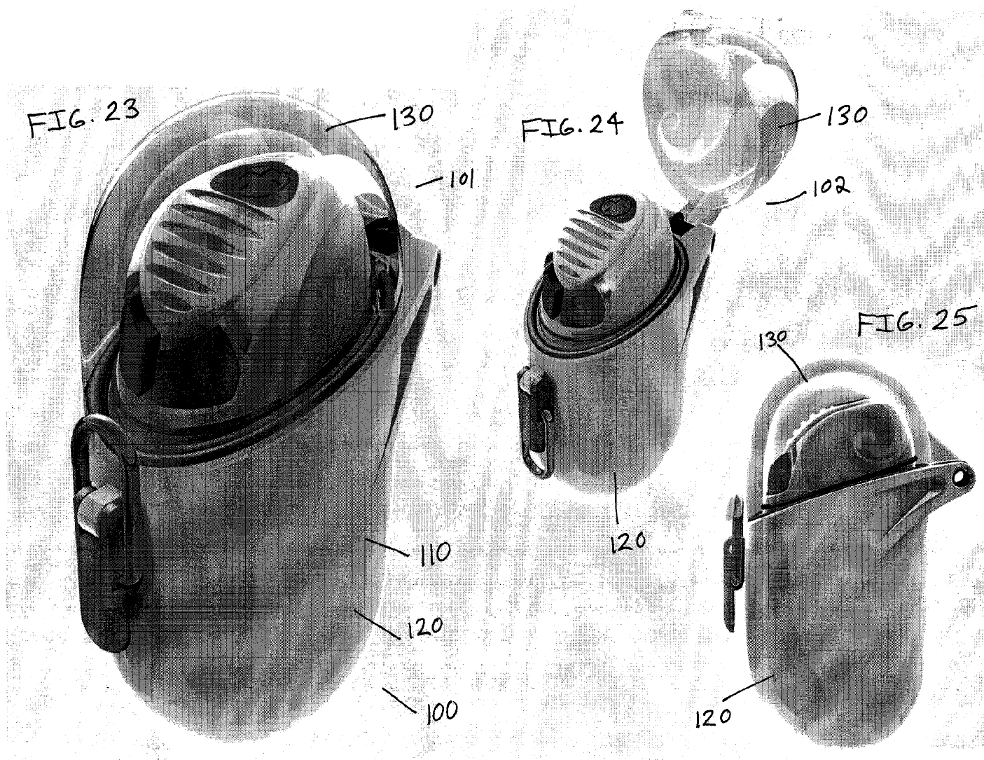

FIG. 23 is a front perspective view illustrating a rescue radio 100 with its lid 130 closed in accordance with an alternate embodiment of the invention. FIG. 24 is a front perspective view illustrating the rescue radio 100 of FIG. 23 with its lid 130 opened in accordance with an alternate embodiment of the invention. And, FIG. 25 is a right side view illustrating the rescue radio 100 of FIG. 23 with its lid 130 closed in accordance with an alternate embodiment of the invention.

According to one embodiment, the enclosure 110 of the rescue radio 100 may have an opaque body 120 and a transparent (or translucent) cap or lid 130.

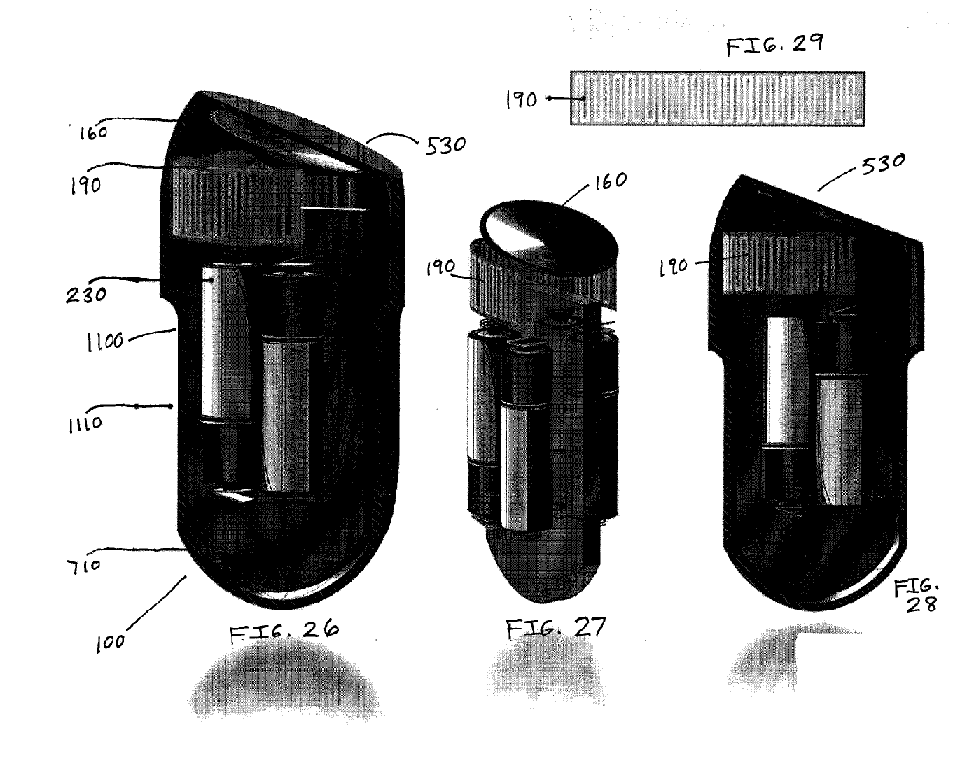

FIG. 26 is a cross sectional perspective view illustrating the core 1100 of a rescue radio 100 in accordance with an alternate embodiment of the invention. FIG. 27 is a front perspective view illustrating the core 1100 of the rescue radio 100 of FIG. 26 with the inner core wall 1110 removed in accordance with an alternate embodiment of the invention. FIG. 28 is a cross sectional view illustrating the core 1100 of the rescue radio 100 of FIG. 26 in accordance with an alternate embodiment of the invention. And, FIG. 29 is a top view illustrating the antenna 190 of the rescue radio 100 of FIG. 26 in flattened out position in accordance with an alternate embodiment of the invention.

According to one embodiment, the antenna 190 may be a flat, flexible antenna which may be contained in the core 1100 of the rescue radio 100 under the cover 530 of the radio system 200.

FIG. 30 is a front perspective view illustrating a rescue radio 100 with its lid 130 closed in accordance with an alternate embodiment of the invention. And, FIG. 31 is a front perspective view illustrating the rescue radio 100 of FIG. 30 with its lid 130 opened in accordance with an alternate embodiment of the invention.

According to one embodiment, the antenna 190 may retract into the core 1100 through an opening 541 formed in the cover 530 of the radio system 200 and hence may be contained within the enclosure 110 when the lid 130 is in the closed position. The antenna 190 may be extendible (e.g., using springs) to its upright operating position when the lid 130 is in the opened position.

FIG. 32 is a front perspective view illustrating a rescue radio 100 with its lid 130 closed in accordance with an alternate embodiment of the invention. And, FIG. 33 is a front perspective view illustrating the rescue radio 100 of FIG. 32 with its lid 130 opened in accordance with an alternate embodiment of the invention.

According to one embodiment, the antenna 190 may fold under the lid 130 and may be contained within the enclosure 110 when the lid 130 is in the closed position. A tip 191 of the antenna 190 may fold or bend under the lid 130 when the lid 130 is closed. The antenna 190 may be extendible (e.g., using springs) to its upright operating position when the lid 130 is in the opened position.

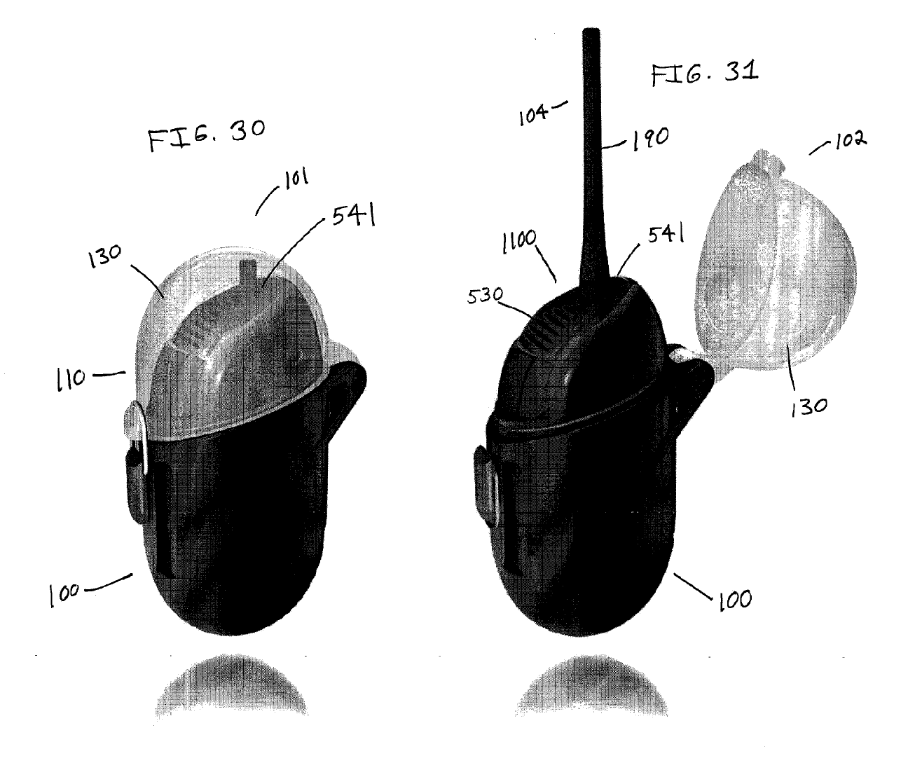

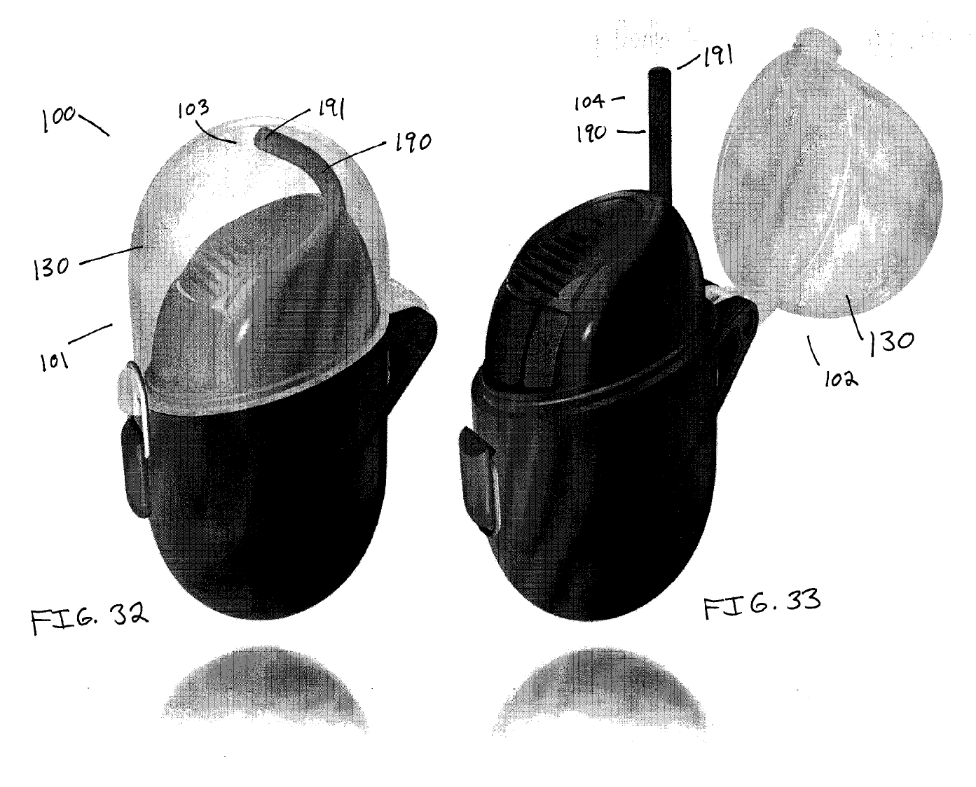

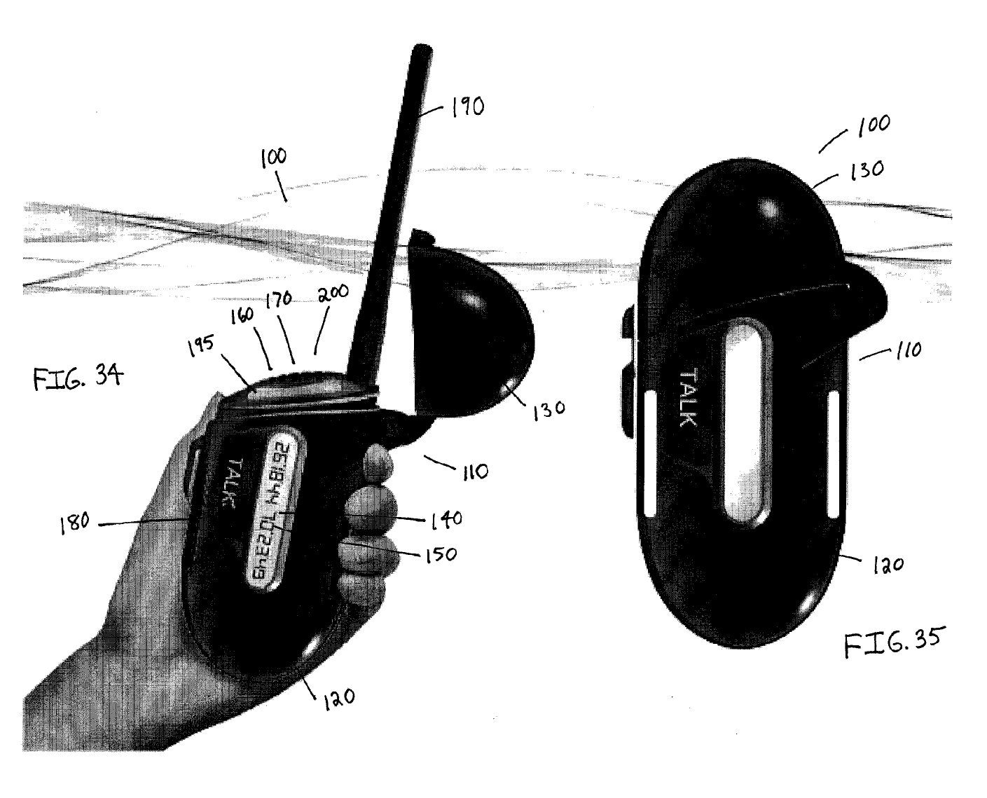

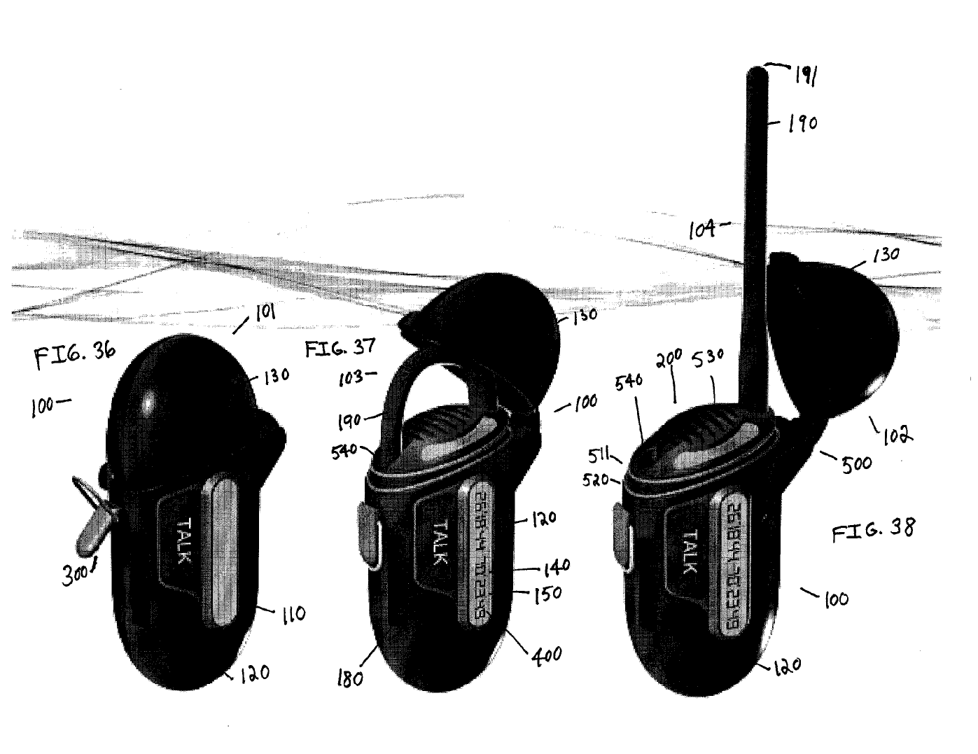

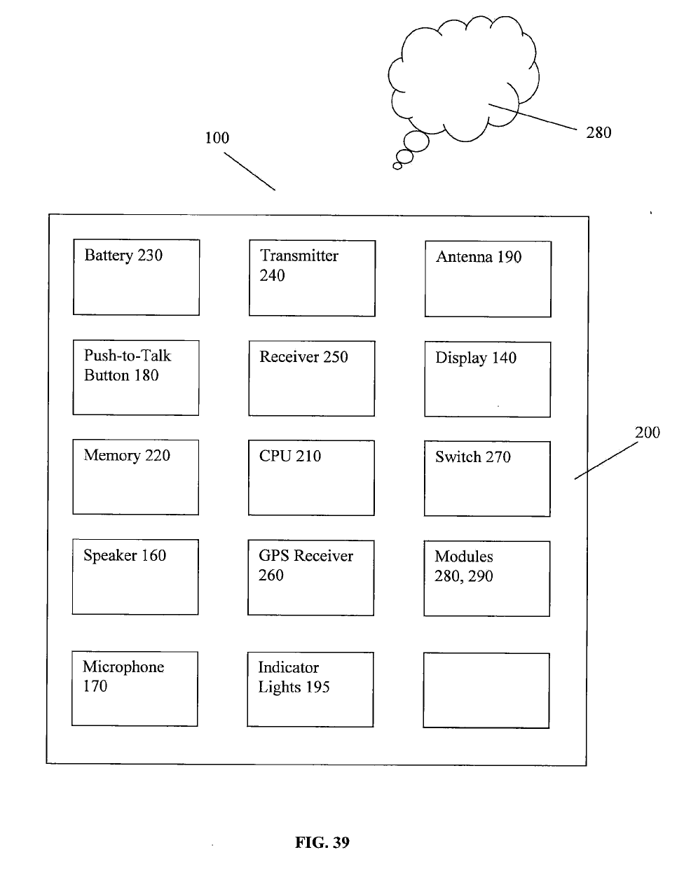

FIG. 34 is a front view illustrating a rescue radio 100 in use with its lid 130 opened in accordance with an alternate embodiment of the invention. FIG. 35 is a front view illustrating the rescue radio 100 of FIG. 34 with its lid 130 closed in accordance with an alternate embodiment of the invention. FIG. 36 is a front perspective view illustrating the rescue radio 100 of FIG. 34 with its lid 130 closed in accordance with an alternate embodiment of the invention. FIG. 37 is a front perspective view illustrating the rescue radio 100 of FIG. 34 with its lid 130 partially open in accordance with an alternate embodiment of the invention. FIG. 38 is a front perspective view illustrating the rescue radio 100 of FIG. 34 with its lid 130 fully opened in accordance with an alternate embodiment of the invention. And, FIG. 39 is a block diagram illustrating the rescue radio 100 of FIG. 34 in accordance with an alternate embodiment of the invention.

Similar to the embodiments of FIGS. 1-33, the rescue radio 100 includes an enclosure 110 having a body 120 and a cap or lid 130, an optional display (e.g., a liquid crystal display (“LCD”)) 140, an optional graphical user interface (“GUI”) 150 displayed on the display 140, and a radio system 200. The radio system 200 includes a speaker 160, a microphone 170, a push-to-talk button 180, an antenna 190, and one or more indicator lights (e.g., light emitting diodes (“LEDs”)) 195. Internally, the radio system 200 of the rescue radio 100 may include one or more circuit boards (not shown), a microprocessor (or central processing unit (“CPU”)) 210 which controls overall operation of the rescue radio 100, memory 220, a battery 230, a transmitter 240, a receiver 250, and optionally a Global Positioning System (“GPS”) receiver 260 which are operatively coupled to the display 140, the speaker 160, the microphone 170, the push-to-talk button 180, the antenna 190, the one or more indicator lights 195, and an on/off switch 270, as will be described below.

According to one embodiment, the rescue radio 100 operates on VHF Channel 16 at 158.6 MHz. According to one embodiment, the rescue radio 100 is configured to operate on Citizens' Band (“CB”) Channel 26 at 28 MHz. According to this embodiment, the rescue radio 100 may be configured for simplex operation. According to one embodiment, the rescue radio 100 is configured to operate on VHF Channel 6. According to one embodiment, the rescue radio 100 is configured to support non-voice signalling (e.g., the rescue radio 100 may have a three second “warble” transmission when turned on).

According to one embodiment, the antenna 190 may fold under the lid 130 and may be contained within the enclosure 110 when the lid 130 is in the closed position 101. A tip 191 of the antenna 190 may fit into a recess 540 formed in a cover 530 of the radio system 200 to hold the antenna 190 in a folded position 103. The antenna 190 may be extendible (e.g., using springs) to its upright operating position 104 when the lid 130 is in the opened position 102.

According to one embodiment, the antenna 190 is made of steel helicoil spring coated in rubber. The antenna 190 springs out automatically when the lid 130 is opened due to the springiness of the coiled steel antenna which acts like a spring and unfurls when the cap or lid 130 is opened. Accordingly to another embodiment, the rescue radio 100 includes a helper spring to unfurl the antenna 190 when the lid 130 is opened.

According to one embodiment, the push-to-talk button 180 and/or display 140 are made waterproof using a rubber membrane sealed into the outer casing or body 120 of the enclosure 110.

According to one embodiment, an on/off switch 270 coupled to the lid 130 detects when the lid 130 has been opened and activates the radio system 200. According to one embodiment, the lid 130 acts as the switch 270. According to one embodiment, upon activation of the radio system 200, the geographic position of the rescue radio 100 obtained from the GPS receiver 260 is presented on the display 140 in degrees of longitude and latitude 400.

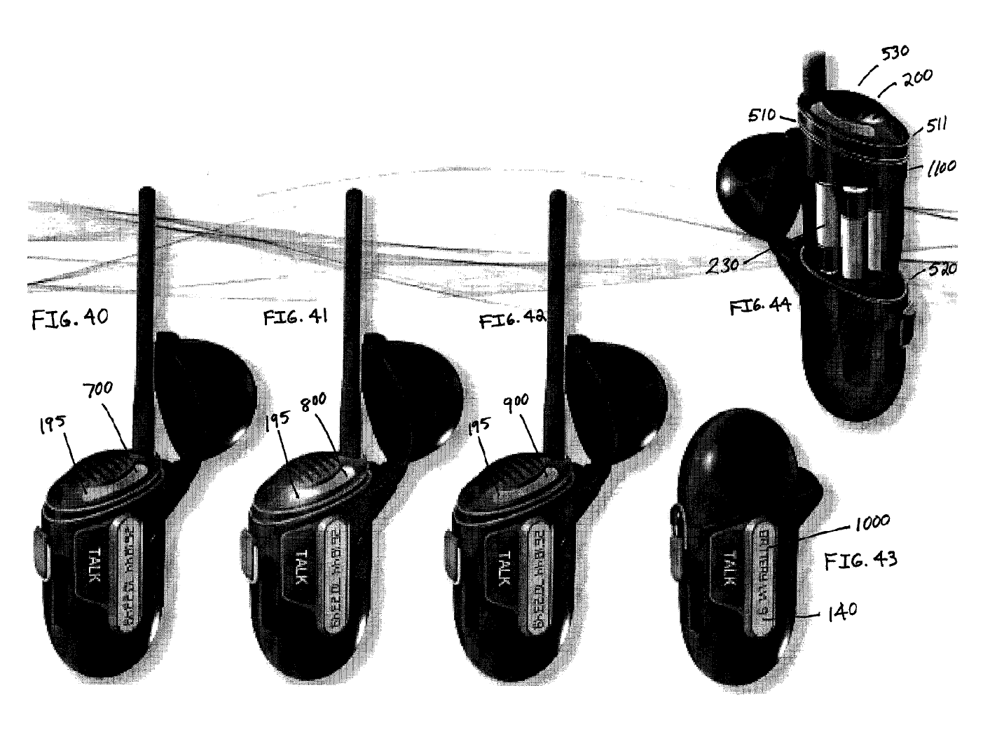

FIG. 40 is a front perspective view illustrating the rescue radio 100 of FIG. 34 in a receive mode in accordance with an alternate embodiment of the invention. FIG. 41 is a front perspective view illustrating the rescue radio 100 of FIG. 34 in a transmit mode in accordance with an alternate embodiment of the invention. FIG. 42 is a front perspective view illustrating the rescue radio 100 of FIG. 34 in a low battery condition in accordance with an alternate embodiment of the invention. FIG. 43 is a front perspective view illustrating the rescue radio 100 of FIG. 34 displaying a battery level in accordance with an alternate embodiment of the invention. And, FIG. 44 is a rear perspective view illustrating the rescue radio 100 of FIG. 34 with its core 1100 in a slid-out position in accordance with an alternate embodiment of the invention.

According to one embodiment, the indicator lights 195 present a first colour 700 (e.g., green) when the radio system 200 is in a receive mode (i.e., when it is receiving a radio signal). According to one embodiment, the indicator lights 195 present a second colour 800 (e.g., amber) when the radio system 200 is in a transmit mode (i.e., when it is transmitting a radio signal). According to one embodiment, the indicator lights 195 present a third colour 900 (e.g., red) to indicate a low battery condition. According to one embodiment, the indicator lights 195 include four light emitting diodes (“LEDs”) with light tubes. Thus, a green indicator light 195 may indicate that the rescue radio 100 is on (e.g., the entire top of the radio 100 lights up). An amber light 195 may indicate that the rescue radio 100 is transmitting. And, a red indicator light 195 may mean that there is, say, 70% battery life left.

According to one embodiment, when the lid 130 is in the closed position, if the push-to-talk button 180 is depressed for a predetermined period (e.g., three seconds), an indication of the battery level 1000 may be presented on the display 140. According to one embodiment, the push-to-talk button 180 may disengage if the diver holds the button down for longer than twenty seconds. And, the squelch and volume settings may be preset at the factory.

According to one embodiment, the radio system 200 of the rescue radio 100 may be mounted in a slide-out or removable core 1100 which may be mounted within the body 120 of the enclosure 110. The removable core 1100 may include a battery interface for receiving one or more batteries 230.

According to one embodiment, the core 1100 is held in the body 120 with a latch than may be rotated by a coin. According to one embodiment, the core 1100 is removed from the body 120 by releasing the latch and pulling the core 1100 upwards and out of the body 120. According to one embodiment, water is kept from getting at the core 1100 when the lid 130 is open by a single or double O-ring bore seal 510.

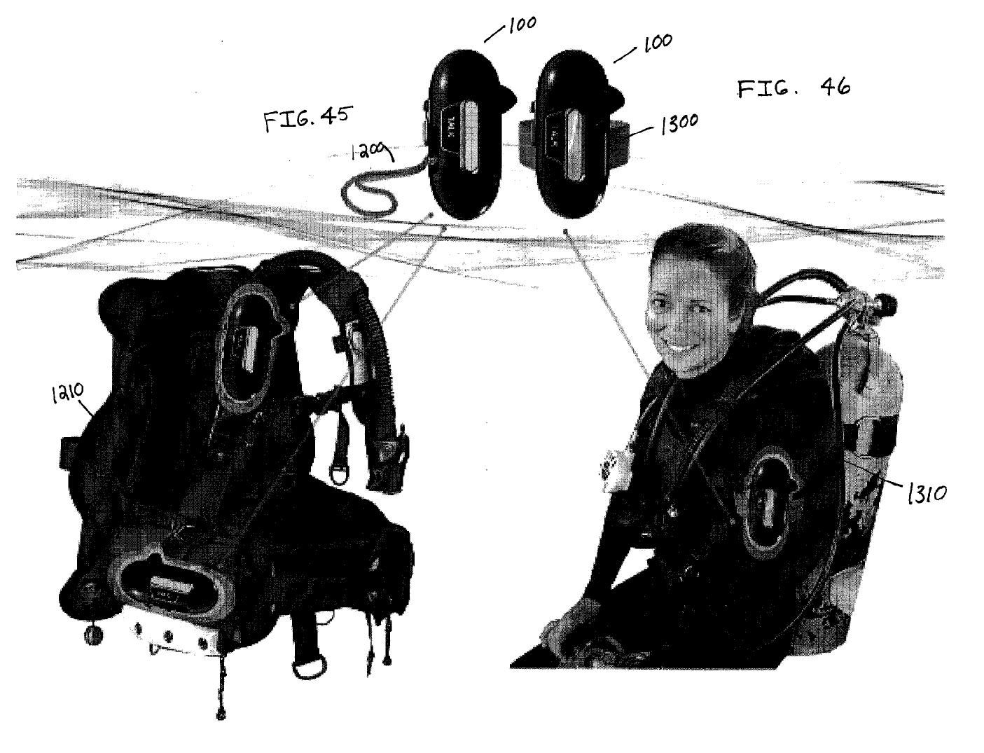

FIG. 45 is a front view illustrating the rescue radio 100 of FIG. 34 equipped with a lanyard attachment 1200 in accordance with an alternate embodiment of the invention. And, FIG. 46 is a front view illustrating the rescue radio 100 of FIG. 34 equipped with an arm band attachment 1300 in accordance with an alternate embodiment of the invention.

According to one embodiment, the rescue radio 100 may be equipped with a lanyard attachment 1200 for securing the rescue radio 100 to a diver's vest 1210. According to another embodiment, the rescue radio 100 may be equipped with an arm band attachment 1300 for securing the rescue radio 100 to a diver's arm 1310. Thus, the rescue radio 100 may have multiple mounting options including a buoyancy control device (“BCD”) shoulder strap with Velcro™, in BCD pocket (same size as a portable phone handset), lanyard, clip to D-ring, Velcro™ to strap onto arm or leg or custom pouch with a clip to D-ring.

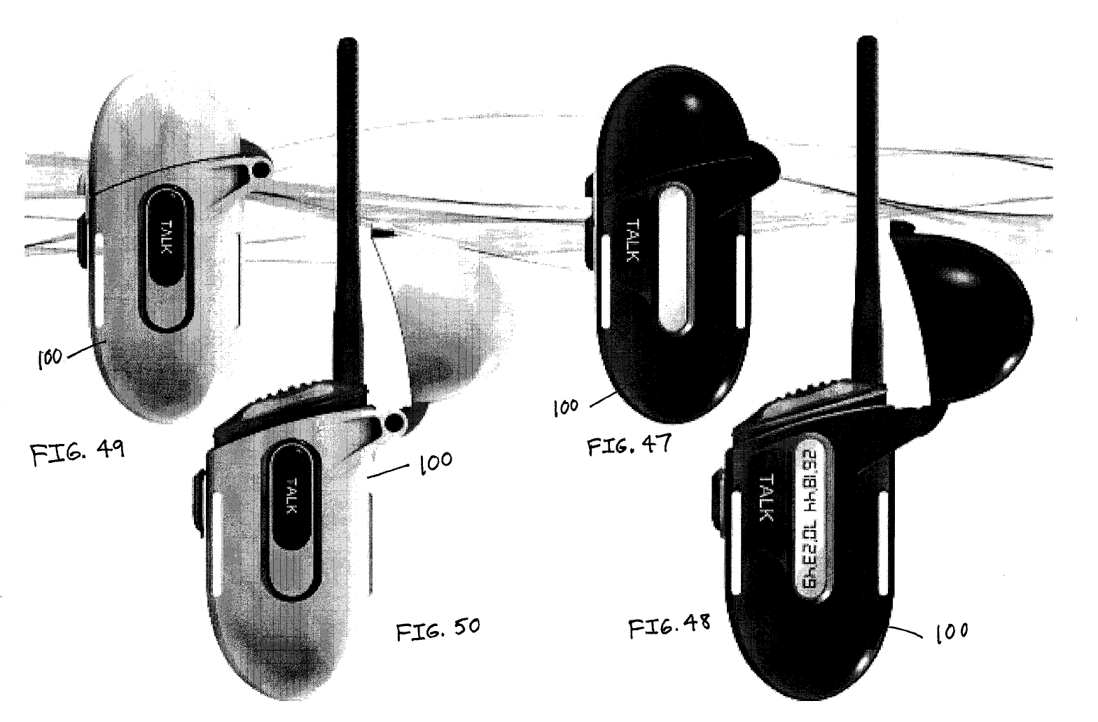

FIG. 47 is an alternate front view illustrating the rescue radio 100 of FIG. 34 with its lid 130 closed in accordance with an alternate embodiment of the invention. FIG. 48 is a front view illustrating the rescue radio 100 of FIG. 34 with its lid 130 opened in accordance with an alternate embodiment of the invention. FIG. 49 is a front view illustrating a rescue radio 100 with its lid 130 closed in accordance with an alternate embodiment of the invention. And, FIG. 50 is a front view illustrating the rescue radio 100 of FIG. 49 with its lid 130 opened in accordance with an alternate embodiment of the invention.

According to an alternate embodiment, the rescue radio 100 does not include a display 140 or a GUI 150. According to one embodiment, the enclosure 110 of the rescue radio 100 may have an opaque body 120 and an opaque cap or lid 130.

Thus, according to one embodiment, there is provided a rescue radio 100 for scuba divers, comprising: an enclosure 110 having a lid 130 and a body 120; the lid 130 being movable between an opened position 102 and a closed position 101; a radio system 200 mounted in a core 1100; the core 1100 mounted in the body 120 of the enclosure 110; the core 1100 having a cover 530 for the radio system 200; a first seal 510 formed or provided between the cover 530 and the body 120 to waterproof the radio system 200 to a first depth when the lid 130 is in the opened position 102; and, a second seal 520 formed or provided between the lid 130 and the body 120 to waterproof the radio system 200 to a second depth when the lid 130 is in the closed position 101; the second depth being greater than the first depth.

In the above rescue radio 100, the first depth may be approximately 3 feet and the second depth may be approximately 330 feet. The radio system 200 may have an antenna 190 contained within the core 1100. The radio system 200 may have an antenna 190 that is extendable to an upright position 104 when the lid 130 is moved from the closed position 101 to the opened position 102. A tip 191 of the antenna 190 may fit into a recess 540 formed in the cover 530 to hold the antenna 190 in a folded position 103 under the lid 130 when the lid 130 is in the closed position 101. The radio system 200 may be a VHF radio system. The lid 130 may be a transparent lid. The rescue radio 100 may further include an indicator light 195 mounted on the cover 530 for indicating a function or status of the radio system 200, the indicator light 195 being visible through the transparent lid 130 when in the closed position 101. At least a portion of the body 120 may be transparent. The rescue radio 100 may further include a display 140 mounted on the core 1100 and visible through the portion of the body 130 for displaying a function, status, or location of the radio system 200. The rescue radio 100 may further include a display 140 mounted on or in an exterior surface of the body 120 for displaying a function, status, or location of the radio system 200. The rescue radio 100 may further include a push-to-talk button 180, a microphone 170, and a speaker 160 mounted on the cover 530 and protected by the lid 130 when in the closed position 101. The lid 130 may be coupled to the body 120 by a hinge 500. The rescue radio 100 may further include a latch 300 for securing the lid 130 to the body 120 in the closed position 101. At least the second seal 520 may be an O-ring. The rescue radio 100 may further include a third seal 511 formed or provided between the cover 530 and the lid 130 to further waterproof the radio system 200 to the second depth when the lid 130 is in the closed position 101. The rescue radio 100 may further include a switch 270, 183 for activating the radio system 200. The switch 270 may activate the radio system 200 when the lid 130 is moved from the closed position 101 to the opened position 102. The switch 270 may be a button 183 mounted on the cover 530. And, the rescue radio 100 may further include a first push-to-talk button 180 for communicating on a first channel, a second push-to-talk button 181 for communicating on a second channel, a distress button 182 for sending a distress signal on a third channel, a microphone 170, and a speaker 160 mounted on the cover 530 and protected by the lid 130 when in the closed position 101.

The above embodiments may contribute to an improved rescue radio 100 for divers and may provide one or more advantages. First, the rescue radio 100 provides a diver with safety and peace of mind that they will not get left behind or lost at sea. Second, the rescue radio 100 is simple and intuitive to use. Third, the rescue radio 100 works anywhere in the world on existing VHF channels. Fourth, no special radios or base stations are required. Fifth, the rescue radio 100 is waterproof to 330 feet. Sixth, the rescue radio 100 typically has a range of 3.5 miles. Seventh, the rescue radio 100 may be powered by Lithium (or AA) batteries. Eighth, the rescue radio 100 has an approximate one pound positive buoyancy. Ninth, the rescue radio 100 is intuitive and easy to use which is very important for a panicked and stressed diver. For example, according to one embodiment, all a diver need do is open the cap or lid 130 to turn the radio 100 on and extend the antenna 190. Tenth, the rescue radio 100 is easy to maintain. A diver need only open the lid 130, check the O-rings 510, 511, 520, and check the color of the indicator lights or light tubes 195 (e.g., Green=good, Red=bad). Eleventh, the rescue radio 100 has multiple mounting options 1200, 1300. Twelfth, the rescue radio 100 may have small dimensions (e.g., approximately 2.6 inches wide, by 2 inches deep, by 5.75 inches high with the lid 130 closed). Thirteenth, in addition, to divers, the rescue radio 100 may be used by kayakers, yachtsmen, commercial and recreational fishermen, or anybody who is on the water and could benefit from the use of an inexpensive, robust, waterproof radio for use on hailing and distress frequencies. Fourteenth, the rescue radio 100 may also be used by divers to communicate with each other.

The embodiments of the invention described above are intended to be exemplary only. Those skilled in this art will understand that various modifications of detail may be made to these embodiments, all of which come within the scope of the invention.

What is claimed is:

1. A rescue radio for scuba divers, comprising:
an enclosure having a lid and a body; the lid being movable between an opened position and a closed position;
a radio system mounted in a core; the core mounted in the body of the enclosure; the core having a cover for the radio system;
a first seal formed or provided between the cover and the body to waterproof the radio system to a first depth when the lid is in the opened position; and,
a second seal formed or provided between the lid and the body to waterproof the radio system to a second depth when the lid is in the closed position; the second depth being greater than the first depth.

2. The rescue radio of claim 1 wherein the first depth is approximately 3 feet and wherein the second depth is approximately 330 feet.

3. The rescue radio of claim 1 wherein the radio system has an antenna contained within the core.

4. The rescue radio of claim 1 wherein the radio system has an antenna that is extendable to an upright position when the lid is moved from the closed position to the opened position.

5. The rescue radio of claim 4 wherein a tip of the antenna is fit into a recess formed in the cover to hold the antenna in a folded position under the lid when the lid is in the closed position.

6. The rescue radio of claim 1 wherein the radio system is a VHF radio system.

7. The rescue radio of claim 1 wherein the lid is a transparent lid.

8. The rescue radio of claim 6 and further comprising an indicator light mounted on the cover for indicating a function or status of the radio system, the indicator light being visible through the transparent lid when in the closed position.

9. The rescue radio of claim 1 wherein at least a portion of the body is transparent.

10. The rescue radio of claim 9 and further comprising a display mounted on the core and visible through the portion of the body for displaying a function, status, or location of the radio system.

11. The rescue radio of claim 1 and further comprising a display mounted on or in an exterior surface of the body for displaying a function, status, or location of the radio system.

12. The rescue radio of claim 1 and further comprising a push-to-talk button, a microphone, and a speaker mounted on the cover and protected by the lid when in the closed position.

13. The rescue radio of claim 1 wherein the lid is coupled to the body by a hinge.

14. The rescue radio of claim 1 and further comprising a latch for securing the lid to the body in the closed position.

15. The rescue radio of claim 1 wherein at least the second seal is an O-ring.

16. The rescue radio of claim 1 and further comprising a third seal formed or provided between the cover and the lid to further waterproof the radio system to the second depth when the lid is in the closed position.

17. The rescue radio of claim 1 and further comprising a switch for activating the radio system.

18. The rescue radio of claim 17 wherein the switch activates the radio system when the lid is moved from the closed position to the opened position.

19. The rescue radio of claim 17 wherein the switch is a button mounted on the cover.

20. The rescue radio of claim 1 and further comprising a first push-to-talk button for communicating on a first channel, a second push-to-talk button for communicating on a second channel, a distress button for sending a distress signal on a third channel, a microphone, and a speaker mounted on the cover and protected by the lid when in the closed position.
